(19) United States
(12) Patent Application Publication
(10) Pub. No.: US 2024/0397133 A1
(43) Pub. Date: Nov. 28, 2024

(54) CONTENT DISTRIBUTION SYSTEM, OPERATION METHOD OF CONTENT DISTRIBUTION SYSTEM, AND PROGRAM

(71) Applicant: SONY GROUP CORPORATION, TOKYO (JP)

(72) Inventor: TETSUGOROU IHARA, TOKYO (JP)

(21) Appl. No.: 18/695,381

(22) PCT Filed: Sep. 27, 2022
(86) PCT No.: PCT/JP2022/035949

§ 371 Date: Mar. 26, 2024

(30) Foreign Application Priority Data
Oct. 7, 2021 (JP) 2021-165268

(51) Int. Cl. H04N 21/266; H04N 21/81

(52) U.S. Cl. CPC H04N 21/266; H04N 21/812

(57) ABSTRACT

The present disclosure relates to a content distribution system, an operation method of the content distribution system, and a program that enable provision of content according to a destination to a passenger boarding a moving body along with movement to the destination. In a content distribution system including: a vehicle; and a server that distributes content to the vehicle, the vehicle sets a route according to travel destination information that is information of a travel destination, and acquires and reproduces content distributed from the server, and the server selects content on the basis of the travel destination information and distributes the content to the vehicle. The present disclosure can be applied to a content distribution system.

### TECHNICAL FIELD

The present disclosure relates to a content distribution system, an operation method of the content distribution system, and a program, and more particularly, to a content distribution system, an operation method of the content distribution system, and a program capable of providing content according to a destination to a passenger boarding a moving body along with movement to the destination.

### BACKGROUND ART

A technology has been proposed in which an autonomous traveling plan of an autonomous traveling vehicle that is a vehicle capable of autonomous traveling and data of a moving image for a passenger of the autonomous traveling vehicle to view in the vehicle are generated, and a behavior of the autonomous traveling vehicle when the autonomous traveling vehicle travels along the autonomous traveling plan and the generated moving image are linked (see Patent Document 1).

In addition, a technology has been proposed in which destination information regarding a destination of a vehicle following a vehicle driving ahead and route information regarding a route to the destination are acquired, and advertisement information regarding the acquired destination information and route information is displayed on a display unit provided behind the vehicle driving ahead and presented to a passenger of the vehicle following (see Patent Document 2).

### CITATION LIST

### Patent Document

Patent Document 1: Japanese Patent Application Laid-Open No. 2020-189579
Patent Document 2: Japanese Patent Application Laid-Open No. 2020-079998

### SUMMARY OF THE INVENTION

### Problems to be Solved by the Invention

However, in the technology described in Patent Documents 1 and 2, content related to the destination of the traveling vehicle is not reproduced, and thus, it is not possible to perform presentation that makes the passenger feel excited until arriving at the destination while moving to the destination.

The present disclosure has been made in view of such a situation, and in particular, an object of the present disclosure is to provide a passenger of a moving body with content related to a destination along with movement to the destination.

### Solutions to Problems

A content distribution system and a program according to one aspect of the present disclosure are a content distribution system and a program, the content distribution system including: a moving body; and a server that distributes content to the moving body, in which the moving body includes: a travel destination information processing unit that executes processing according to travel destination information that is information of a travel destination; and a content reproduction unit that acquires and reproduces the content distributed by the server, and the server includes a content distribution unit that selects the content on the basis of the travel destination information and distributes the content to the moving body.

An operation method of a content distribution system according to one aspect of the present disclosure is an operation method of a content distribution system including: a moving body; and a server that distributes content to the moving body, the moving body including: a travel destination information processing unit that executes processing according to travel destination information that is information of a travel destination; and a content reproduction unit that acquires and reproduces the content distributed by the server, the server including a content distribution unit that selects the content on the basis of the travel destination information and distributes the content to the moving body, the operation method including the steps of: executing, by the travel destination information processing unit, processing according to the travel destination information; acquiring and reproducing, by the content reproduction unit, the content distributed from the server; and selecting, by the content distribution unit, the content on the basis of the travel destination information and distributing the content to the moving body.

In one aspect of the present disclosure, a process according to travel destination information which is information of a travel destination is executed by a moving body, the content distributed by the server is acquired and reproduced, and the content is selected by the server on the basis of the travel destination information and distributed to the moving body.

### BRIEF DESCRIPTION OF DRAWINGS

FIG. 1 is a diagram for explaining an outline of a first embodiment of the present disclosure.

FIG. 2 is a diagram for explaining a configuration example of the first embodiment of a content reproduction system of the present disclosure.

FIG. 3 is a diagram for explaining a configuration example of a vehicle of FIG. 2.

FIG. 4 is a block diagram illustrating a configuration example of a content server of FIG. 2.

FIG. 5 is a diagram for explaining a configuration example of a content DB.

FIG. 6 is a diagram for explaining a configuration example of a travel destination DB.

FIG. 7 is a flowchart for explaining a content reproduction process by the content reproduction system of FIG. 2.

FIG. 8 is a flowchart for explaining a route setting process in the flowchart of FIG. 7.

FIG. 9 is a flowchart for explaining a content list generation process in the flowchart of FIG. 7.

FIG. 10 is a flowchart for explaining a content selection process of the flowchart of FIG. 7.

FIG. 11 is a flowchart for explaining a package generation process of the flowchart of FIG. 7.

FIG. 12 is a flowchart for explaining an output process of the flowchart of FIG. 7.

FIG. 13 is a diagram for explaining an outline of a second embodiment of the present disclosure.

FIG. 14 is a diagram for explaining a configuration example of the second embodiment of a content reproduction system of the present disclosure.

FIG. 15 is a diagram for explaining a configuration example of an advertisement server of FIG. 14.

FIG. 16 is a diagram for explaining a configuration example of an advertisement DB.

FIG. 17 is a diagram for explaining a configuration example of an advertisement medium DB.

FIG. 18 is a flowchart for explaining a content reproduction process by the content reproduction system of FIG. 14.

FIG. 19 is a flowchart for explaining a package organization process of the flowchart of FIG. 18.

FIG. 20 is a flowchart for explaining an advertisement selection process of the flowchart of FIG. 18.

FIG. 21 is a flowchart for explaining a package generation process of the flowchart of FIG. 18.

FIG. 22 is a flowchart for explaining an output process of the flowchart of FIG. 18.

FIG. 23 is a flowchart for explaining a return way content reproduction process by the content reproduction system of FIG. 14.

FIG. 24 is a flowchart for explaining a return route setting process in the flowchart of FIG. 23.

FIG. 25 is a flowchart for explaining a return way content list generation process of the flowchart of FIG. 18.

FIG. 26 illustrates a configuration example of a general-purpose computer.

### MODE FOR CARRYING OUT THE INVENTION

Hereinafter, preferred embodiments of the present disclosure will be described in detail with reference to the accompanying drawings. Note that, in the present specification and drawings, components having substantially the same functional configuration are denoted by the same reference signs, and redundant description is omitted.

Hereinafter, modes for carrying out the present technology will be described. The description is given in the following order.
1. First Embodiment
2. Second Embodiment
3. Application Example of Second Embodiment
4. Example of Execution by Software

### 1. First Embodiment

### <Outline of First Embodiment>

In particular, the present disclosure provides a passenger boarding a moving body with content according to a destination along with movement to the destination.

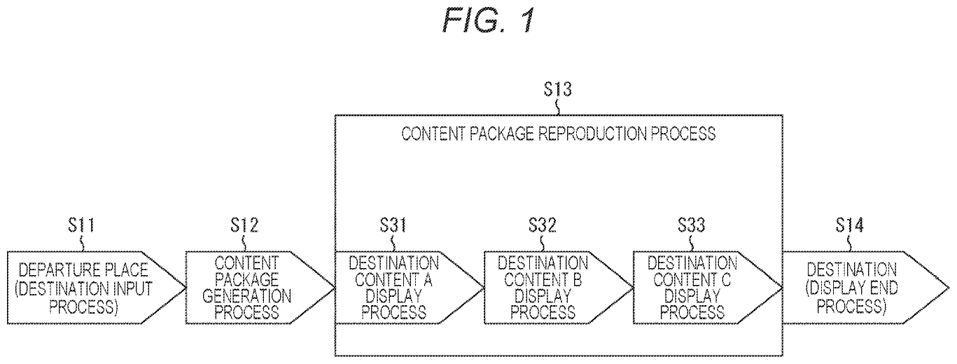

First, with reference to FIG. 1, an outline of a first embodiment of a content reproduction system capable of providing content according to a destination to a passenger along with movement of a moving body to the destination will be described.

In the present disclosure, when information about a destination is input at a current location that is a departure place, a list of contents related to the destination is generated as a content list from the input information regarding the destination, and destination contents selected from the content list are sequentially reproduced until the destination is reached.

That is, as illustrated in FIG. 1, in the process of step S11, which is the first process, information of the destination is input by the passenger at the departure place.

In step S12, a route from the departure place to the destination is set on the basis of the information of the destination, and content related to the destination is searched for, and a content list, which is a list of search results, is generated and presented to the passenger.

When the passenger selects the content desired to be reproduced from the content list, the selected destination content is organized, and a packaged content package is generated from the organization result.

In the example of FIG. 1, in a case where destination contents A to C are selected from a content list, the destination contents A to C are organized, and a content package is generated from the organization result.

As a result, in step S13, the movement of the moving body to the destination is started by navigation to the destination or automated driving, the content package reproduction process is executed, and the content package including the destination content selected from the content list is sequentially reproduced until the destination is reached.

In the example of FIG. 1, the content package includes destination contents A to C.

Therefore, in step S31, the destination content A display process is executed, and the destination content A is reproduced. Then, when the reproduction of the destination content A is completed, subsequently, in step S32, the destination content B display process is executed, and the destination content B is reproduced. Further, when the reproduction of the destination content B is ended, the destination content C display process is executed and the process of reproducing the destination content C is sequentially executed in step S33.

Then, in step S14, when the destination is reached, the content package reproduction process ends, the display end process is performed, and the series of processing ends.

According to the above processing, when the passenger boarding the moving body sets the destination and sets navigation or automated driving, destination content related to the destination is searched for and listed according to the destination, and presented as a content list. Then, when content desired to be reproduced is selected from the presented content list, a content package including the selected content is generated, and destination content based on the content package is sequentially reproduced.

As a result, the passenger of the moving body sequentially views the content related to the destination while moving to the destination, and thus, it is possible to enhance expectation and thought for the action after arrival while immersing in the world of the content even until arriving at the destination.

Note that, in the above, an example has been described in which content is searched according to a destination, a list of the searched content is generated as a content list, a content package including destination content selected from the generated content list is generated, and the content package is reproduced.

However, among the contents searched as the contents related to the destination, a predetermined number of contents which are frequently selected when other passengers of other moving bodies set the same destination may be selected from the top, and a content package may be generated from the selected destination contents and reproduced.

In this case, the passenger can view the destination content related to the destination while moving only by setting the destination, particularly, without particularly selecting the content desired to be reproduced from the content list.

### <Configuration Example of Content Reproduction System According to First Embodiment of Present Disclosure>

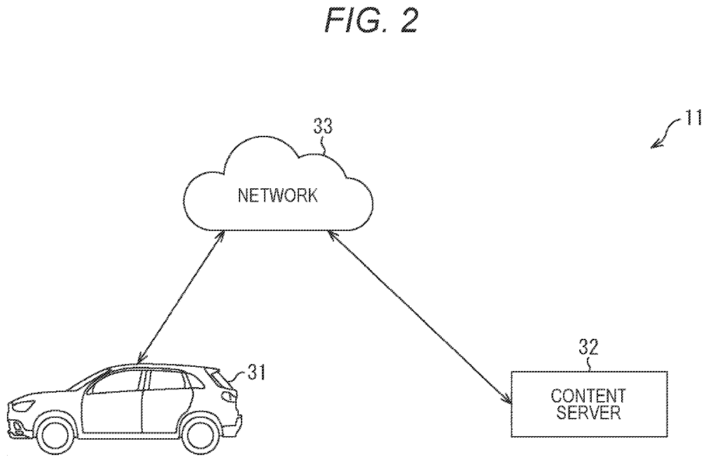

Next, a configuration example of a content reproduction system as the first embodiment of the present disclosure will be described with reference to FIG. 2.

A content reproduction system 11 in FIG. 2 includes a vehicle 31, a content server 32, and a network 33.

The vehicle 31 is a moving body that is operated by a passenger or moves to a destination by automated driving.

The vehicle 31 receives information of a destination by an operation input operated by a passenger, searches for a route to the destination, sets a route to the destination which is a search result, and implements navigation based on the route to the destination or implements automated driving to the destination.

In addition, when receiving the input of the destination, the vehicle 31 generates travel information including information of the destination and the route, and transmits the travel information to the content server 32 via the network 33. The travel information includes information of a destination and a route, information of a relay point, and information such as a scheduled travel distance and a time required for arrival.

The vehicle 31 acquires a content list which is a list of contents related to a destination generated on the basis of the travel information from the content server 32. Then, the vehicle 31 presents the acquired content list (playlist) to the passenger, and presents information prompting selection of destination content desired to be reproduced from the content list. The content includes video, games, music, audio, still images (including a slide show of still images in which the display is continuously switched), and the like. The content list to be presented may be configured according to the travel distance and the time required for arrival. For example, in a case where the content has a reproduction time like a video or music, a playlist of destination content combined so that the total reproduction time of each content falls within the time required for arrival may be automatically generated.

The vehicle 31 receives input of information of destination content selected by an operation of a passenger from the content list, generates content configuration information by configuring various settings related to a reproduction timing and display of the selected destination content, and supplies the content configuration information to the content server 32 via the network 33.

The vehicle 31 acquires a content package generated on the basis of the content configuration information from the content server 32 and reproduces the content package while moving to the destination. That is, the content package includes destination content selected by the passenger and desired to be reproduced, and the destination content is sequentially reproduced with the movement.

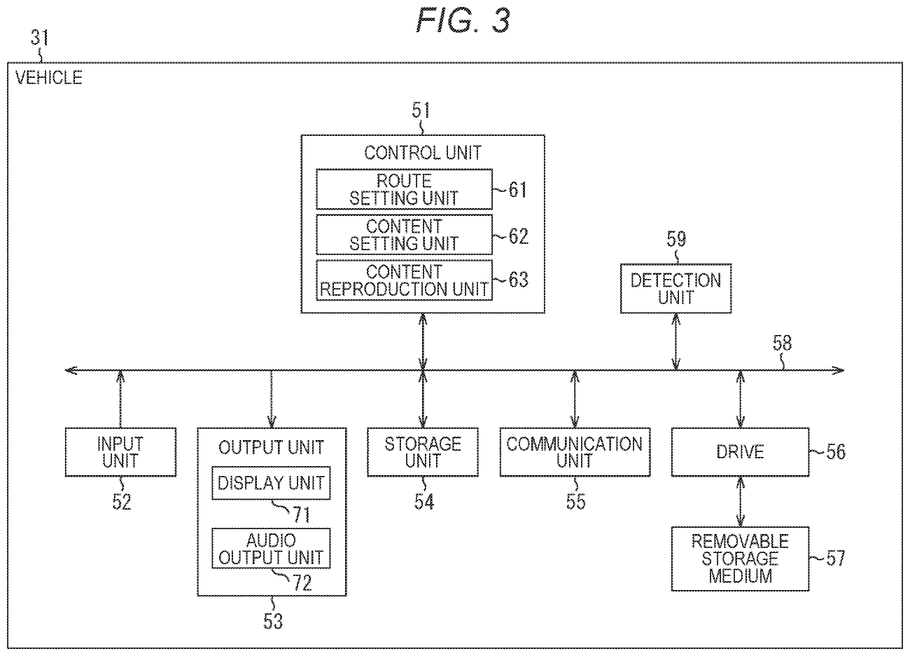

The vehicle 31 includes, as output devices, at least one a display unit 71 (FIG. 3) or an audio output unit 72 (FIG. 3) that reproduces destination content according to content such as video, game, music, audio, and still image.

The display unit 71 includes an output device such as a display including organic electro luminescence (EL), a liquid crystal display (LCD), or the like. However, the display unit 71 includes not only an organic EL and an LCD but also various display devices such as an operation screen and a navigation display screen of a navigation device, a head-up display, a road surface projection irradiation device, a rear seat monitor, a tail lamp, and a projector that projects an image on a side window or a rear window. Furthermore, the audio output unit 72 is, for example, a speaker that outputs audio, music, a sound effect, and includes various audio output devices such as a plurality of speakers according to contents of video, game, music, audio, still image, and the like, and a vibrator that generates vibration.

Note that, hereinafter, display devices that display various video/image contents including video, games, and still images, audio output devices that reproduce audio, music, and sound effects, and the like are collectively referred to as output devices.

The content package is set for each output device, for example, and the destination content is reproduced by the output device corresponding to the type of content such as video, image, audio, music, and sound effect.

For example, in a case where the content included in the content package is a still image, the content package is set for each of the output devices constituting the display unit 71. Like a so-called collective change function, still images relating to characters appearing in animations and comics may be simultaneously and uniformly displayed in all display areas such as an operation screen and a navigation display screen of a navigation device, a head-up display, a road surface projection irradiation device, and a side window and a rear window.

Similarly, for example, in a case where the content included in the content package is audio such as music, the content package is set for each of the output devices constituting the audio output unit 72.

Furthermore, a plurality of output devices may be used for reproducing the same content. In other words, in a case where the content is a movie, an image and audio are output by using an output device of any of the display unit 71 (FIG. 3) and an output device of any of the audio output unit 72 (FIG. 3). In a case where a plurality of output devices is used in this way, the plurality of output devices to be used is regarded as one integrated output device, and the content package is set.

The content server 32 is implemented by a server computer connected to the network 33 or cloud computing, and searches for content related to a destination according to travel information supplied from the vehicle 31, generates a content list, and supplies the content list to the vehicle 31.

The content related to the destination is, for example, a moving image, music (audio), and an image including information around the destination, a moving image, music (audio), and an image including information of a passing position on a route to move to the destination and a position within a predetermined distance from the route, and the like. Specifically, in a case where the destination is a theme park or the like handling a predetermined character, the content related to the destination is a movie, a drama, an animation, music, or the like in which the predetermined character appears.

In addition, the content server 32 reads the content data for reproducing the destination content on the basis of the content configuration information including the reproduction timing and various presentation settings of the destination content selected from the content list by the passenger of the vehicle 31, and further, generates a content package for reproducing the content in a state where the reproduction timing and the various presentation settings are performed on the basis of the read content data, and supplies the content package to the vehicle 31.

The reproduction timing of each content set in the content configuration information may be set such that, for example, in a case where content related to a position where the vehicle passes on a route to a destination is selected, each content is reproduced at a timing when the vehicle 31 passes near the corresponding position.

The reproduction timing may be set in accordance with the order specified from the number of times of viewing the content, the viewing history of the passenger, and the like.

Furthermore, for example, in a case where the content relates to a predetermined character, the presentation setting is a setting of presentation such as an audio effect in which a sound of the character is reproduced according to position information such as latitude and longitude, or a visual effect in which an image related to the character is projected in the vehicle interior such as projection mapping.

Note that although the vehicle 31 is used as an example of a moving body in the example of FIG. 2, any other moving body may be used as long as the moving body moves to a destination with a passenger on board, and the moving body may be, for example, a railway, an aircraft, a ship, a mobile robot, or the like.

Furthermore, in the content reproduction system 11 of FIG. 2, a configuration in which one vehicle 31 and one content server 32 are connected via the network 33 is illustrated, but a plurality of vehicles 31 and content servers 32 may be provided for the network 33.

### <Configuration Example of Vehicle>

Next, a configuration example of the vehicle 31 will be described with reference to FIG. 3.

The vehicle 31 includes a control unit 51, an input unit 52, an output unit 53, a storage unit 54, a communication unit 55, a drive 56, a removable storage medium 57, and a detection unit 59, and is connected to each other via a bus 58, and can transmit and receive data and programs.

The control unit 51 includes a processor and a memory, and controls the entire operation of the vehicle 31. Furthermore, the control unit 51 includes a route setting unit 61, a content setting unit 62, and a content reproduction unit 63.

When the input unit 52 is operated and input of destination information is received, the route setting unit 61 searches for a route from the departure place to the destination, sets a route to the searched destination, and controls the display unit 71 and the audio output unit 72 of the output unit 53 to present navigation information to the passenger. Furthermore, when the vehicle 31 can perform automated driving by autonomous traveling, the automated driving is implemented according to the searched route.

When the input unit 52 is operated and the input of the destination is received, the content setting unit 62 controls the communication unit 55 to transmit the travel information including the information of the destination and the information of the route set by the route setting unit 61 to the content server 32 via the network 33.

The content setting unit 62 controls the communication unit 55 to acquire a content list which is a list of contents related to a destination searched for according to the destination and supplied from the content server 32, and presents the content list on the display unit 71 of the output unit 53, and presents information prompting selection of desired content.

The content setting unit 62 controls the communication unit 55 to transmit the information of the destination content selected from the content list to the content server 32 by operating the input unit 52.

When the content reproduction unit 63 controls the communication unit 55 to acquire the content package including the destination content selected from the content list and supplied from the content server 32 for each output device, the content reproduction unit 63 controls the display unit 71 and the audio output unit 72 of the output unit 53 to reproduce the content package for each output device.

The input unit 52 includes an input device such as a keyboard, a mouse, or a touch panel to which a passenger of the vehicle 31 as a user inputs an operation command, and supplies various input signals to the control unit 51.

The output unit 53 is controlled by the control unit 51, and includes a display unit 71 and an audio output unit 72. The output unit 53 outputs an operation screen or an image of a processing result to the display unit 71 including a display device including a liquid crystal display (LCD), an organic electro luminescence (EL), or the like, and displays the operation screen or the image. Furthermore, the output unit 53 controls the audio output unit 72 including an audio output device to reproduce various sounds, music, sound effects, and the like.

As described above, the display unit 71 includes not only a display including an organic EL, an LCD, or the like, but also various display devices such as an operation screen or a navigation screen of a navigation device, a head-up display, a road surface projection irradiation device, a rear seat monitor, a tail lamp, and a projector that projects an image on a side window or a rear window. Furthermore, the audio output unit 72 includes not only a speaker that outputs audio but also a device that outputs various types of vibration and audio such as a vibrator that generates vibration according to the content of video, game, music, audio, still image, and the like.

Note that, although not illustrated, the output unit 53 may include, in addition to the display unit 71 and the audio output unit 72, an aroma emission unit that generates aroma and a device output unit from which a toy such as a telescopic hand having a boxing glove at its tip protrudes.

The storage unit 54 includes a hard disk drive (HDD), a solid state drive (SSD), a semiconductor memory, or the like, is controlled by the control unit 51, and writes or reads various data and programs including content data.

The communication unit 55 is controlled by the control unit 51, implements communication represented by a local area network (LAN), Bluetooth (registered trademark), or the like in a wired or wireless manner, and transmits and receives various data and programs to and from various devices via the network 33 as necessary.

The drive 56 reads and writes data from and to the removable storage medium 57 such as a magnetic disk (including a flexible disk), an optical disk (including a compact disc-read only memory (CD-ROM) and a digital versatile disc (DVD)), a magneto-optical disk (including a Mini Disc (MD)), or a semiconductor memory.

The detection unit 59 is controlled by the control unit 51, detects the position of the current location of the vehicle 31 on the earth by a radio wave from a satellite (not illustrated) such as a global positioning system (GPS), for example, and outputs the position to the control unit 51. Furthermore, the detection unit 59 records the position of the detected current location in time series, and outputs the position to the control unit 51 as a passage history.

### <Configuration Example of Content Server>

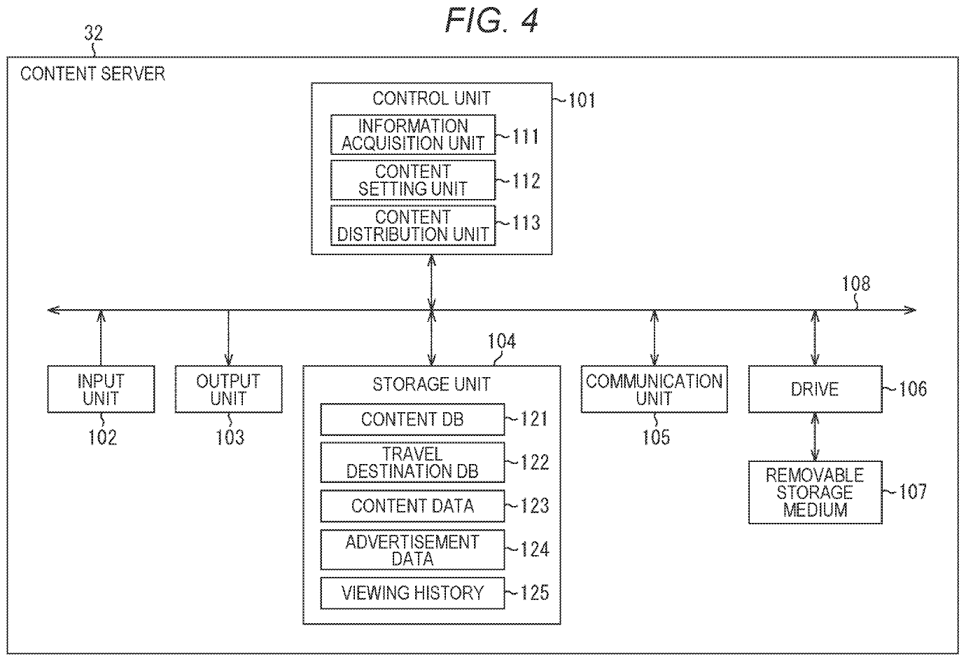

Next, a configuration example of the content server 32 will be described with reference to FIG. 4.

The content server 32 includes a control unit 101, an input unit 102, an output unit 103, a storage unit 104, a communication unit 105, a drive 106, and a removable storage medium 107, and is connected to each other via a bus 108, and can transmit and receive data and programs.

Note that the control unit 101, the input unit 102, the output unit 103, the storage unit 104, the communication unit 105, the drive 106, the removable storage medium 107, and the bus 108 of the content server 32 in FIG. 4 have configurations corresponding to the control unit 51, the input unit 52, the output unit 53, the storage unit 54, the communication unit 55, the drive 56, the removable storage medium 57, and the bus 58 of the vehicle 31 in FIG. 3, and thus, description thereof is appropriately omitted as necessary.

However, unlike the output unit 53 of the vehicle 31, the output unit 103 is not an output device required for reproducing content, but is, for example, an output device provided in a general personal computer or the like, and displays various processing results and the like.

Furthermore, FIG. 4 illustrates an example in which the content server 32 is configured by a single computer or the like, but may be implemented by cloud computing by a plurality of computers or a plurality of servers on a network.

The control unit 101 includes a processor and a memory, and controls the entire operation of the content server 32. Furthermore, the control unit 101 includes an information acquisition unit 111, a content setting unit 112, and a content distribution unit 113.

The information acquisition unit 111 controls the communication unit 105 to acquire the travel information transmitted from the vehicle 31. In addition, the information acquisition unit 111 acquires content configuration information including content selected from a content list generated on the basis of the travel information.

On the basis of the travel information acquired by the information acquisition unit 111, the content setting unit 112 searches for travel destination data that is information including a feature of a travel destination corresponding to a destination on the basis of a travel destination database (DB) 122 that is a database of information indicating a feature of each travel destination set to the destination stored in the storage unit 104.

The content setting unit 112 searches a content database (DB) 121 that is a database of information indicating a feature of content on the basis of travel destination data corresponding to the searched destination, and searches for content that is the same as or similar to (highly related or correlated to) a feature included in the travel destination data that is the destination. Then, the content setting unit 112 generates a content list on the basis of the searched content and transmits the content list to the vehicle 31.

The content setting unit 112 searches and reads the content data 123 including the main body data for reproducing the content on the basis of the information of the destination content selected from the content list, and generates the content package.

The content setting unit 112 considers that the information (for example, a content ID or the like for identifying content) of the content used to generate the content package is viewed by the passenger in the vehicle 31, and stores the information in the viewing history 125 of the storage unit 104.

The content distribution unit 113 controls the communication unit 105 to transmit the generated content package to the vehicle 31.

The input unit 102 includes input devices such as a keyboard, a mouse, and a touch panel for inputting an operation command operated by the user of the content server 32, and supplies various input signals to the control unit 51.

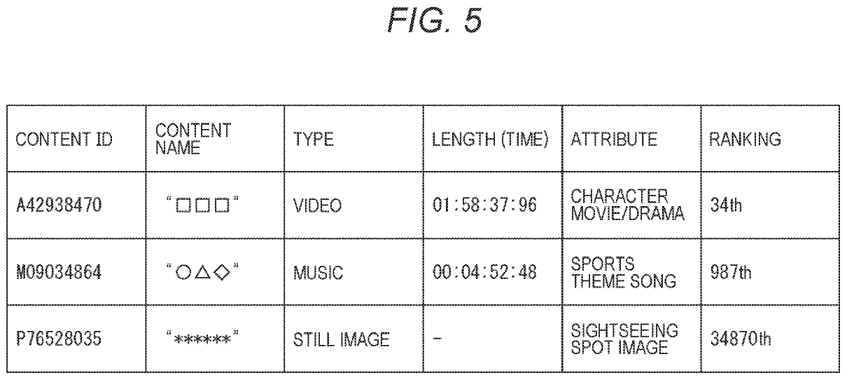

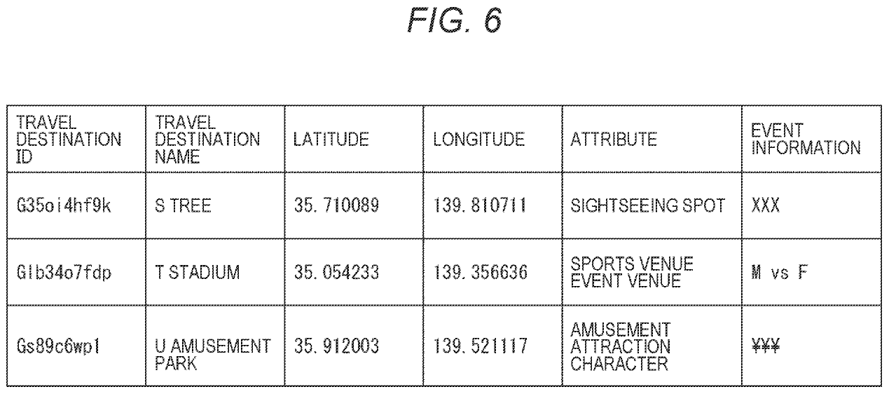

The storage unit 104 stores a content DB 121 in which information indicating features of each content such as video, game, music, audio, and still image reproduced in the vehicle 31 is stored as a database. In addition, the storage unit 104 stores a travel destination DB 122 in which features for each destination are stored in a database. Note that the configurations of the content DB 121 and the travel destination DB 122 will be described later in detail with reference to FIGS. 5 and 6.

The storage unit 104 stores content data 123 serving as main body data used for reproducing content.

Note that, in the drawing, the content data 123 is illustrated as a single piece of data, but actually exists as many as the number of pieces of content, and is stored as information identified by the content ID.

When content is reproduced, the storage unit 104 stores advertisement data 124 which is main body data of an advertisement to be reproduced correspondingly.

Note that, in the drawing, similarly to the content data 123, the advertisement data 124 is also illustrated as a single piece of data, but in reality, the advertisement data exists as many as the number of advertisements and is stored as information identified by advertisement IDs.

Furthermore, since the advertisement data 124 is information used in the second embodiment described later and is not an essential configuration in the first embodiment, it may be omitted in the first embodiment.

### <Configuration Example of Content DB>

Next, a configuration example of the content DB 121 will be described with reference to FIG. 5.

The content DB 121 is a database indicating a feature of each content including a video, a game, music, audio, and a still image.

More specifically, as illustrated in FIG. 5, the content DB 121 includes a content ID, a content name, a type, a length (time), an attribute, and a ranking.

The content ID is an identifier for identifying each content, and is expressed by, for example, an alphabet and a numerical value. The content name is information indicating the name of each content. The type is information indicating the type of content, and is, for example, information indicating whether the content is a video, a game, music, audio, a still image, or the like.

The length (time) is information indicating the reproduction time of the content. However, since the reproduction time is not defined for a still image, the still image is expressed as “-”. In the case of a slide show in which a plurality of still images is repeatedly displayed, one loop is regarded as a reproduction time.

The attribute is information indicating an attribute of content. In a case where the content is a video such as a moving image, when the content is a movie or a drama mainly including a predetermined character or the like, the content is classified as “character movie/drama”. Similarly, since the attribute is information for classifying content, for example, “action movie”, “love drama”, “criminal drama” and the like are also included.

Furthermore, in a case where the content is music, for example, when the content is a theme song of a drama or a movie, a specific sports theme song, a hit song, a standard song of a season, or the like, the content is classified into “drama/movie theme song”, “sports theme song”, “hit song”, “standard song of a season”, or the like, which identifies each of the content.

Furthermore, in a case where the content is a still image, the content is, for example, information indicating an imaging target or the like, and is, for example, a “sightseeing spot image”, a “character image”, a “vehicle image”, or the like.

Furthermore, the ranking is information indicating a rank set for each content, and is, for example, information indicating a rank of the number of times of reproduction for each content.

More specifically, in FIG. 5, “A42938470”, “M09034864”, and “P76528035” are written as the content IDs from the top.

Further, the contents with the content ID of “A42938470” are indicated as follows: the content name is “□□□”, the type is “video”, the length (time) is 1 hour 58 minutes 37 seconds 96, the attribute is “character movie/drama”, and the ranking is “34th”.

Further, the contents with the content ID of “M09034864” are indicated as follows: the content name is “∘Δ⋄”, the type is “music”, the length (time) is 4 minutes 52 seconds 48, the attribute is “sports theme song”, and the ranking is “987th”.

Further, the contents with the content ID of “P76528035” are indicated as follows: the content name is “******”, the type is “still image”, the length (time) is “-”, the attribute is “sightseeing spot image”, and the ranking is “34870th”.

As described above, the content DB 121 is a database of information indicating a feature of each content, and content having a feature same as or similar to a feature of a travel destination that is a destination is searched for, so that content related to the destination (having high relevance or correlation with the destination) is searched for.

### <Configuration Example of Travel Destination DB>

Next, a configuration example of the travel destination DB 122 will be described with reference to FIG. 6.

The travel destination DB 122 is a database of information indicating features of a travel destination set as a destination.

More specifically, as illustrated in FIG. 6, the travel destination DB 122 includes a travel destination ID, a travel destination name, latitude, longitude, an attribute, and event information.

The travel destination ID is an identifier for identifying the travel destination, and is expressed by, for example, an alphabet and a numerical value. The travel destination name is information indicating a name of a facility, a building, or the like existing at a travel destination position.

The latitude and longitude are information indicating a latitude value and a longitude value indicating the location of the travel destination on the earth, and are expressed in a range of 0 degrees to 180 degrees, respectively.

The attribute is information indicating an attribute of something existing in a travel destination place. For example, in the case of famous historical sites, sightseeing spots, and the like, the attribute is set as “sightseeing spot”. In the case of a venue facility where sports or an event is held, the attribute is set as “sports venue or event venue”. In the case of an amusement park, a game facility, and the like, the attribute is set as “amusement, attraction, or character”.

The event information is information indicating an event held at a place as a travel destination, and for example, in the case of a held event name, sports, or the like, a battle team name or the like is registered.

More specifically, in the case of FIG. 6, the travel destination ID is indicated as “G35oi4hf9k”, “Glb34o7fdp”, and “Gs89c6wp1” from the top.

Further, the travel destination with the travel destination ID “G35oi4hf9k” is indicated as follows: the travel destination name is “S tree”, the latitude is “35.710089”, the longitude is “139.810711”, the attribute is “sightseeing spot”, and the event information is “XXX”.

In addition, the travel destination with the travel destination ID “Glb34o7fdp” is indicated as follows: the travel destination name is “T stadium”, the latitude is “35.054223”, the longitude is “139.356636”, the attribute is “sports venue or event venue”, and the event information is “M vs F”, indicating that it is a game of M team versus F team.

Further, the travel destination with the travel destination ID “Gs89c6wp1” is indicated as follows: the travel destination name is “U amusement park”, the latitude is “35.912003”, the longitude is “139.521117”, the attribute is “amusement, attraction, or character”, and the event information is “¥¥¥”.

As described above, the travel destination DB 122 is formed with a database of information indicating a feature for each travel destination set as a destination, and content having a feature same as or similar to the feature of the travel destination searched for according to the travel destination, which is the destination, is searched for in the content DB 121 described above, whereby content related to the destination (having high relevance or correlation with the destination) is searched for.

### <Content Reproduction Process by Content Reproduction System in FIG. 2>

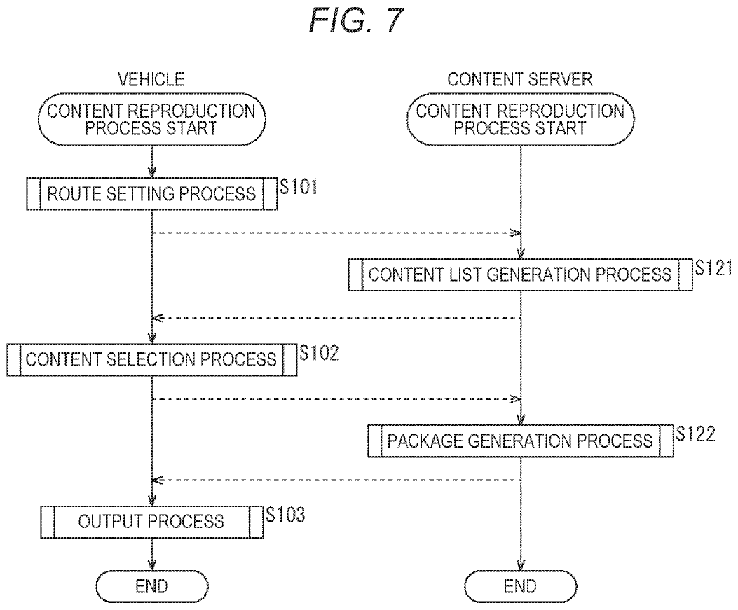

Next, a content reproduction process by the content reproduction system in FIG. 2 will be described with reference to a flowchart in FIG. 7.

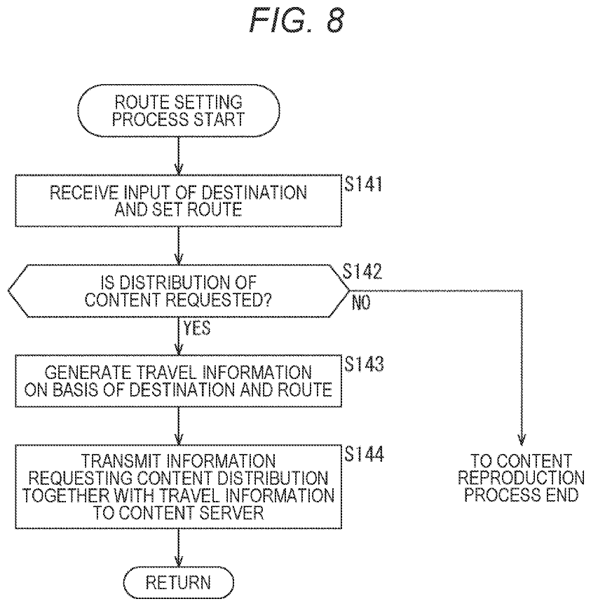

In step S101, the vehicle 31 executes a route setting process, sets a route from the current location to the destination, generates travel information including the destination and the route on the basis of the set route, and transmits the travel information to the content server 32. Note that the route setting process will be described later in detail with reference to the flowchart of FIG. 8.

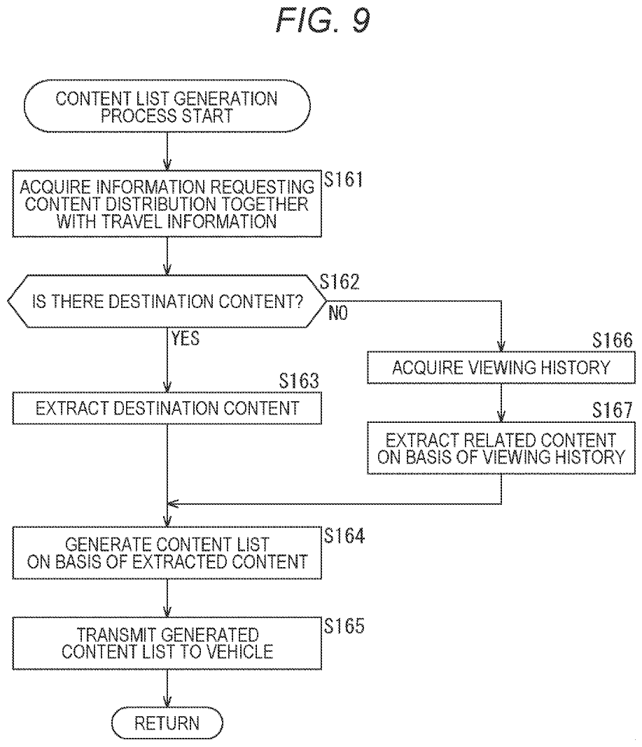

In step S121, the content server 32 executes content list generation process, searches for content related to the destination included in the travel information, generates a content list, and transmits the content list to the vehicle 31. Note that the content list generation process will be described later in detail with reference to the flowchart of FIG. 9.

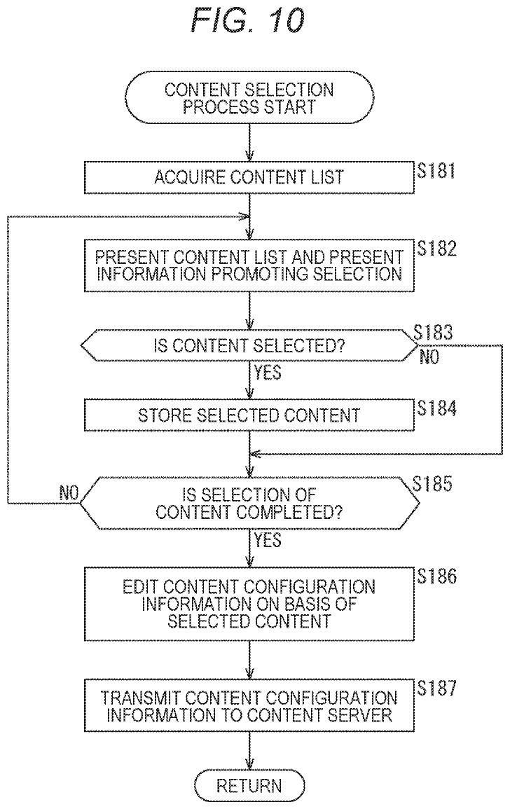

In step S102, the vehicle 31 executes the content selection process, and when the content desired to be reproduced is selected from the content list by the passenger, the content configuration information such as the reproduction timing and the presentation setting related to various types of reproduction is generated on the basis of the selected content, and is transmitted to the content server 32. Note that the content selection process will be described later in detail with reference to the flowchart of FIG. 10.

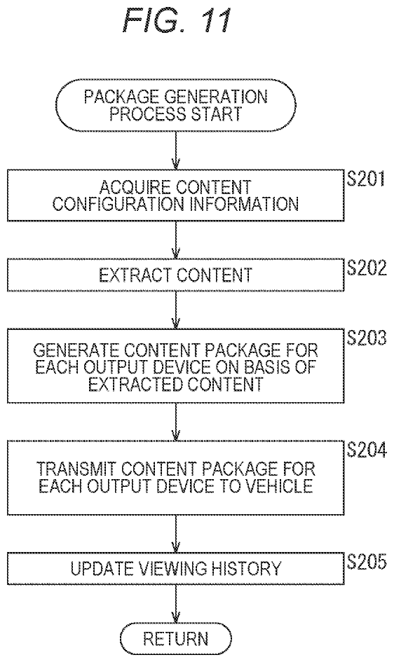

In step S122, the content server 32 executes the package generation process, reads the content data 123 which is the main body data of the content desired to be reproduced on the basis of the content configuration information, generates the reproduction control information for controlling the reproduction at the time of reproducing the content based on the content data 123 corresponding to the reproduction timing and the presentation setting related to various kinds of reproduction, packages the generated content package, and transmits the generated content package to the vehicle 31. Note that the package generation process will be described later in detail with reference to the flowchart of FIG. 11.

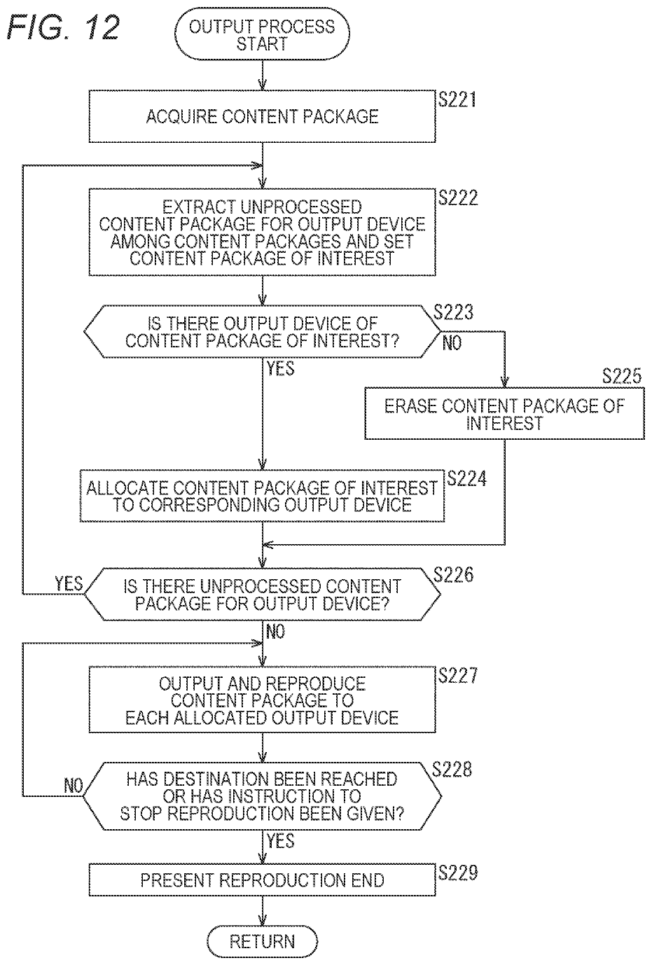

In step S103, the vehicle 31 executes the output process and reproduces the content package generated on the basis of the content configuration. Note that the output process will be described later in detail with reference to the flowchart of FIG. 12.

Through the above series of processing, it is possible to cause the vehicle 31 to reproduce the content related to the destination along with the movement from the departure place to the destination.

As a result, since content related to the destination can be reproduced and presented to the passenger while moving to the destination, it is possible to strongly impart the image and interest of the destination while immersing in the world of the content even until the passenger arrives at the destination, and it is possible to enhance the feeling toward the destination.

### <Route Setting Process in Flowchart of FIG. 7>

Next, the route setting process in the flowchart of FIG. 7 will be described with reference to the flowchart of FIG. 8.

In step S141, the route setting unit 61 of the vehicle 31 controls the display unit 71 and the audio output unit 73 of the output unit 53 to output information prompting input of a destination as an image and audio. In response to this, when the input unit 52 is operated to receive the input of the destination, the route setting unit 61 searches for and sets a route from the departure place (current location) to the destination from the information of the current location which is the departure place detected by the detection unit 59 and the destination for which the input has been received.

In step S142, the route setting unit 61 controls the display unit 71 and the audio output unit 73 of the output unit 53 to output, as an image and audio, information prompting the input of information indicating whether or not the distribution of the content related to the destination is requested before the arrival at the destination. Then, the route setting unit 61 determines whether or not the input unit 52 has been operated and information requesting distribution of content related to the destination has been input.

In a case where it is determined in step S142 that the input unit 52 is operated and distribution of content related to the destination is requested, the processing proceeds to step S143.

In step S143, the route setting unit 61 generates travel information in which the destination and the set route are collected on the basis of the destination and the route.

In step S144, the route setting unit 61 controls the communication unit 55 to transmit information requesting distribution of content related to the destination together with the travel information to the content server 32 via the network 33, and ends the processing.

Note that, in a case where the distribution of the content related to the destination is not requested in step S142, the content reproduction process ends.

That is, by the above processing, the travel information including the destination and the route from the departure place to the destination set according to the destination, and the information requesting the distribution of the content related to the destination are transmitted to the content server 32. Note that the information requesting distribution of content related to the destination may include identification information for identifying the vehicle 31.

### <Content List Generation Process in Flowchart of FIG. 7>

Next, the content list generation process in the flowchart of FIG. 7 will be described with reference to the flowchart of FIG. 9.

In step S161, the information acquisition unit 111 of the content server 32 controls the communication unit 105 to acquire the travel information transmitted from the vehicle 31 and the information requesting the distribution of the content via the network 33. At this time, the information acquisition unit 111 extracts information for identifying the vehicle 31 from the information requesting the distribution of the content.

In step S162, the content setting unit 112 searches for content (destination content) related to (highly related to or correlated with) the destination included in the travel information acquired by the information acquisition unit 111, and determines the presence or absence of the content based on whether or not the content is searched for.

More specifically, the content setting unit 112 accesses the travel destination DB 122 stored in the storage unit 104, searches for travel destination data indicating a feature of a travel destination set as a destination, and then further accesses the content DB 121, and searches for content having a feature with high relevance or correlation that is the same as or similar to the feature of the travel destination data searched for corresponding to the destination.

Here, the content setting unit 112 determines the presence or absence of content related to the destination on the basis of whether or not the destination content is searched for.

For example, in a case where the travel destination DB 122 has a configuration as illustrated in FIG. 6, when “S tree” is set as the destination, the content setting unit 112 searches for information of the travel destination ID “G35oi4hf9k” in which the travel destination name “S tree” is registered as the travel destination data.

In addition, in a case where the position of the destination is within a predetermined distance on the basis of the position specified from the information of latitude and longitude among the travel destination data of the travel destination DB 122, the corresponding travel destination data may be searched for. That is, when the destination position is within the predetermined distance from the position specified by the latitude of “35.710089” and the longitude of “139.810711” in the travel destination data in the uppermost row in FIG. 6, the content setting unit 112 may search for the corresponding travel destination ID “G35oi4hf9k” as the travel destination data. In this case, information with the travel destination ID “G35oi4hf9k”, where the travel destination name is “S tree”, the latitude is “35.710089”, the longitude is “139.810711”, the attribute is “sightseeing spot”, and the event information is “XXX”, is set as the search result of the travel destination data 122.

Further, the content setting unit 112 searches the content DB 121 on the basis of the information indicating the feature included in the searched travel destination data.

That is, here, since the search result of the travel destination data is the travel destination ID “G35oi4hf9k” in FIG. 6, “sightseeing spot” is included as the attribute. Therefore, for example, when searching the content DB 121 in FIG. 5, the content setting unit 112 may search for content having a content ID of “P76528035”, which includes “sightseeing spot image” including the keyword of “sightseeing” in the attribute, as content related to the destination.

Furthermore, for example, in a case where “T stadium” is set as the destination, the travel destination data with the travel destination ID “Glb34o7fdp” in FIG. 6 is searched for. In this case, “sports venue or event venue” is included as the attribute. Therefore, for example, when searching the content DB 121 in FIG. 5, the content setting unit 112 may search for content with the content ID of “M09034864” as content related to the destination, the content including “sports theme song” including the keyword of “sports” in the attribute.

Furthermore, for example, in a case where “U amusement park” is set as the destination, “Gs89c6wp1” is searched for as the travel destination ID in FIG. 6. In this case, “amusement, attraction, or character” is included as the attribute. Therefore, for example, when searching the content DB 121 in FIG. 5, the content setting unit 112 may search for content having a content ID of “A42938470”, which includes “character movie/drama” including “character” in the attribute, as content related to the destination.

In addition, the content may be searched using the reproduction time (length) of the content as the narrowing condition among the content related to the destination in light of the scheduled time until arrival included in the travel information. For example, when the time until arrival is 1 hour 20 minutes, the content setting unit 112 excludes the content ID “A42938470” whose length (time) is 01:58:37:96 from the search target, and searches for content related to the destination.

In the above description, an example has been described in which travel destination data set as a destination is searched from the travel destination DB 122. However, a plurality of positions existing on a route to a destination may be regarded as destinations and searched from the travel destination DB 122, so that content having a feature with high relevance or correlation, the feature being the same as or similar to the feature of each travel destination data, may be searched.

In a case where content related to the destination is searched for and it is determined that there is content related to the destination in step S162 on the basis of such a search result, the processing proceeds to step S163.

In step S163, the content setting unit 112 extracts information of all the contents searched as the contents related to the travel destination set as the destination.

In step S164, the content setting unit 112 generates a content list as a list of content related to the destination on the basis of the extracted content.

In step S165, the content setting unit 112 controls the communication unit 105 to transmit the generated content list to the vehicle 31 corresponding to the information for identifying the vehicle 31 included in the information requesting the distribution of the content via the network 33.

On the other hand, in step S162, in a case where content related to the destination is not searched for and it is determined that there is no content related to the destination, the processing proceeds to step S166.

In step S166, the content setting unit 112 accesses the viewing history 125 stored in the storage unit 104, and acquires the viewing history data registered in association with the information for identifying the vehicle 31.

In step S167, the content setting unit 112 searches for and extracts the content included in the searched viewing history data as the related content of the destination.

The related content referred to herein is content at a level lower in relevance or correlation indicating the relationship with the destination than the destination content, and is, for example, content existing within a predetermined distance from the current destination and having a relationship with travel destination data set as the destination in the past, content viewed when the destination is set in the same time zone from the date and time when the current destination is set, for example, if the current time is in the morning on Saturday in the past, or the like.

In this case, in step S164, the content setting unit 112 generates a content list as a list of related content on the basis of the extracted related content.

By the above processing, in a case where content related to the destination is searched for in step S162, a content list as a list of content related to the destination is generated and transmitted to the vehicle 31, and in a case where related content is searched for, a content list as a list of related content is generated and transmitted to the vehicle 31.

### <Content Selection Process in Flowchart of FIG. 7>

Next, the content selection process in the flowchart of FIG. 7 will be described with reference to the flowchart of FIG. 10.

In step S181, the content setting unit 62 of the vehicle 31 controls the communication unit 55 to acquire the content list transmitted from the content server 32 via the network 33.

In step S182, the content setting unit 62 displays information as a list of contents related to the destination on the display unit 71 of the output unit 53 as, for example, a playlist on the basis of the acquired content list, and presents information prompting selection of desired content.

In step S183, the content setting unit 62 determines whether or not the input unit 52 is operated and the content in the playlist (content list) is selected.

In a case where the content is selected in step S183, the processing proceeds to step S184.

In step S184, the content setting unit 62 stores the content selected by operating the input unit 52. Here, when the content is selected, various presentation settings related to the reproduction timing of the selected content and the reproduction of the content may be implemented. Furthermore, in a case where the total of the reproduction times of the selected content is a combination exceeding the scheduled time until arrival, a warning may be issued, and information prompting the selection again may be presented.

For example, in a case where the selected content is a still image or a moving image and there is a plurality of output devices capable of displaying the still image or the moving image inside the vehicle 31, the presentation setting is information for specifying which output device is to be used for display. Furthermore, in a case where the selected content is a still image or a moving image, when display using an avatar is performed, the presentation setting includes character setting for setting the avatar to a specific character, so-called change display setting for switching and displaying wallpaper in an area where the wallpaper is displayed, and the like.

Furthermore, for example, in a case where the selected content is audio, music, or a sound effect, when there is a plurality of output devices capable of outputting audio inside the vehicle 31, the presentation setting is information for specifying which output device is used to output audio, volume, or the like.

Furthermore, with respect to the reproduction timing, the reproduction order, and the presentation setting for each content, default settings may be prepared in advance, and in particular, in a case where there is no instruction or designation from the passenger, the default settings may be used.

Note that, in a case where it is determined in step S183 that no content is selected, the processing in step S184 is skipped.

In step S185, the content setting unit 62 determines whether or not the input unit 52 is operated to perform the operation indicating that the selection of the content is completed, and in a case where the operation indicating that the selection of the content is completed is not performed, the processing returns to step S182.

That is, the processing of steps S182 to S185 is repeated until it is determined that the operation indicating that the selection of the content is completed is performed.

Then, in a case where it is determined in step S185 that the operation indicating that the selection of the content is completed is performed, the processing proceeds to step S186.

In step S186, the content setting unit 62 edits the content configuration information on the basis of the selected content.

The content configuration is, for example, information indicating the reproduction timing and the reproduction order of all the selected content and the presentation setting of each content.

Therefore, in the processing of step S184, the content setting unit 62 edits the content configuration information in which the set reproduction timing and order and the presentation setting are reflected and reproduced.

Furthermore, with respect to the reproduction timing of the content, for example, in a case where the content is searched on the basis of travel destination data when a plurality of positions existing on a route to a destination is regarded as a destination, the content configuration information may be edited so that the reproduction timing at which the corresponding content is reproduced is set at the timing of passing through the corresponding position on the route.

In step S187, the content setting unit 62 controls the communication unit 55 to transmit the content configuration information to the content server 32.

Through the above processing, the content selected by the passenger as the content desired to be reproduced on the basis of the content list, and the content configuration information indicating the reproduction timing and order, and the presentation setting are generated and transmitted to the content server 32.

### <Package Generation Process in Flowchart of FIG. 7>

Next, the package generation process in the flowchart of FIG. 7 will be described with reference to the flowchart of FIG. 11.

In step S201, the content distribution unit 113 controls the communication unit 105 to acquire the content configuration information transmitted from the vehicle 31 via the network 33.

In step S202, the content distribution unit 113 extracts the main body data of the content included in the acquired content configuration from the content data 123.

In step S203, the content distribution unit 113 generates a content package by packaging the content data 123, which is main body data of the extracted content, for each corresponding output device.

At this time, the content distribution unit 113 generates the reproduction control information to be used at the time of reproducing the content on the basis of the set reproduction timing and order for each content included in the content configuration information and the presentation setting, packages the content data together with the generated reproduction control information, and generates a content package for each output device. The reproduction control information also includes information indicating by which output device each content package is reproduced.

In step S204, the content distribution unit 113 controls the communication unit 105 to transmit (distribute) the generated content package for each output device to the vehicle 31.

In step S205, the content distribution unit 113 updates the viewing history 125 of the storage unit 104 on the basis of the generated content package for each output device. That is, the content selected from the content list included in the content package is regarded as being reproduced and viewed in the vehicle 31, and is updated by being added to the viewing history 125 as new information.

Through the above processing, a content package is generated for each output device on the basis of the content configuration information, and is transmitted (distributed) to the vehicle 31.

### <Output Process in Flowchart of FIG. 7>

Next, the output process in the flowchart of FIG. 7 will be described with reference to the flowchart of FIG. 12.

In step S221, the content reproduction unit 63 controls the communication unit 55 to acquire the content package for each output device transmitted from the content server 32 via the network 33.

In step S222, the content reproduction unit 63 extracts an unprocessed content package for an output device from among the acquired content packages, and sets the content package as a content package of interest which is a content package of interest as a processing target.

In step S223, the content reproduction unit 63 determines whether or not there is a set output device on the basis of the reproduction control information of the content package of interest.

That is, it is determined whether or not there is an output device required for reproduction on the basis of the information of the output device required for reproduction recorded in the reproduction control information included in the content package set in the content package of interest.

For example, in a case where a projection display device that projects an image on a side window or a rear window is designated as an output device that reproduces content, when there is no output device corresponding to the vehicle 31, the content package of interest cannot be reproduced. Therefore, it is determined whether or not there is an output device set as the content package of interest and reproduction is possible. In step S223, in a case where there is an output device set as the content package of interest, the processing proceeds to step S224.

In step S224, the content reproduction unit 63 performs the allocation such that the content can be reproduced in the output device corresponding to the content package of interest.

On the other hand, in step S223, in a case where there is no output device set as the content package of interest, the processing proceeds to step S225.

In step S225, the content reproduction unit 63 erases the content package of interest.

That is, in this case, there is no output device for reproducing the content package of interest, and the reproduction itself is impossible, so that the content package of interest is erased. In this case, since the content desired by the passenger is not reproduced, information indicating that the content cannot be reproduced because there is no output device may be presented using the display unit 71 or the audio output unit 72.

In step S226, the content reproduction unit 63 determines whether or not there is an unprocessed content package for an output device among the acquired content packages.

In step S226, in a case where there is an unprocessed content package for an output device, the processing returns to step S222. That is, the processing of steps S222 to S226 is repeated until there is no unprocessed content package for the output device.

Then, in step S226, in a case where there is no unprocessed content package for the output device, the processing proceeds to step S227.

In step S227, the content reproduction unit 63 controls the display unit 71 and the audio output unit 72 of the output unit 53 to output and reproduce the content package from the output devices assigned thereto. At this time, the content reproduction unit 63 performs processing corresponding to the reproduction timing and order of each content and the presentation setting on the content based on the reproduction control information included in each content package, and causes the content to be output from the designated output device.

In step S228, the content reproduction unit 63 determines whether or not the destination has been reached or the input unit 52 has been operated and an instruction to stop reproduction has been given.

In step S228, in a case where the destination has not been reached and the instruction to stop the reproduction by the operation input of the input unit 52 is not given, the processing returns to step S227. That is, in a case where the destination has not been reached and the instruction to stop the reproduction by the operation input of the input unit 52 is not given, the processing of steps S227 and S228 is repeated, and the content package is output from the output device to which the content package is allocated and reproduced is repeated.

Then, in a case where it is determined in step S228 that the destination has been reached or an instruction to stop reproduction by the operation input of the input unit 52 is given, the processing proceeds to step S229.

In step S229, the content setting unit 62 stops the reproduction of the content package and controls the display unit 71 and the audio output unit 72 to present the end of the reproduction by the image and the audio, and ends the processing.

By the above series of processing, when the destination is set, a content list including content related to the destination or related content is generated, content desired to be reproduced is selected on the basis of the content list, and a content package including the selected destination content is generated, distributed to the vehicle 31, and reproduced.

As a result, the content related to the destination can be reproduced in the vehicle 31 along with the movement from the departure place to the destination.

At this time, according to the content configuration information, for example, the content corresponding to the predetermined position is reproduced at the timing of passing through the predetermined position on the route with the movement of the vehicle 31, or the presentation is performed by the presentation setting according to the position, so that the passenger can view (listen) the content according to the scene during the movement.

Furthermore, by reproducing and presenting the content related to the destination to the passenger while moving to the destination, it is possible to strongly impart an image of the destination while immersing in the world of the content even until the passenger arrives at the destination, and it is possible to enhance the feeling for the destination.

### 2. Second Embodiment

### <Outline of Second Embodiment>

In the above description, an example has been described in which content according to a destination is searched for as destination content, a content list is generated, and a content package including content selected from the content list is generated and reproduced.

However, when the destination content is reproduced, an advertisement related to the destination or the destination content may be further displayed between the destination contents, at predetermined time intervals, or the like.

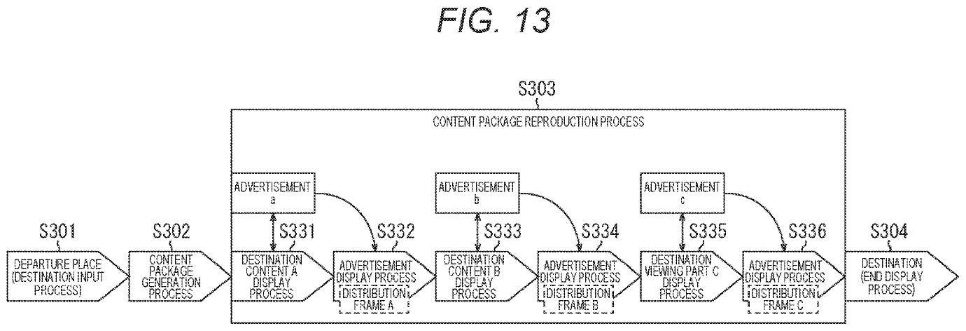

Here, an outline of a second embodiment in which content and an advertisement according to a destination of the present disclosure are reproduced will be described with reference to FIG. 13.

Note that the processing of steps S301, S302, and S304 in FIG. 13 basically corresponds to the processing of steps S11, S12, and S14 described with reference to FIG. 1, and thus description thereof is omitted.

However, in step S302, when the content package is generated, an advertisement related to the destination content (related to the destination) is selected together with the destination content, a distribution frame in which the selected advertisement is reproduced is set, and the content package with advertisement is generated together.

In the example of FIG. 13, destination contents A to C are selected from a content list that is a list of contents related to a destination, and a content package including the destination contents A to C is generated.

Further, in the destination content A, an advertisement a having a relationship with the destination content A (high relevance or correlation) is set in association, and at this time, a distribution frame A in which the advertisement a is reproduced is set.

In addition, similarly, in the destination content B, an advertisement b having a relationship with the destination content B is set in association, and at this time, a distribution frame B in which the advertisement b is reproduced is set.

Furthermore, similarly, in the destination content C, an advertisement c having a relationship with the destination content C is set in association, and at this time, a distribution frame C in which the advertisement c is reproduced is set.

Note that the destination content included in the content package with advertisement is displayed or reproduced on the output device according to the type of content, and the distribution frames A to C of the advertisement set for each content are, for example, information for specifying what format and at what timing to display using what display device, such as which of the display screen of the navigation device, the head-up display, or any monitor of the display unit 71 is used for reproduction, and which distribution frame is simply reproduced during viewing of the content like a television CM, whether to display the content with a banner, a pop-up, or the like, or whether to reproduce the advertisement with only audio from the audio output unit 72. That is, the distribution frames A to C mentioned here can also be considered as presentation settings when the destination content is reproduced.

Therefore, in step S331, the destination content A display process is executed, the destination content A is reproduced, and when the process ends, in step S332, the advertisement display process of displaying the advertisement a related to the destination content A on the distribution frame A is executed, and the advertisement is displayed or reproduced on the set output device.

In addition, when the advertisement display process, which is the process in step S332, ends, in step S333, the destination content B display process is executed, and the destination content B is reproduced. Then, when the destination content B display process of step S333 ends, an advertisement display process of displaying the advertisement b related to the destination content B in the distribution frame B is executed in step S334, and the advertisement b is displayed or reproduced on the set output device.

Furthermore, when the advertisement display process, which is the process of step S334, ends, a destination content C display process is executed in step S335, and the destination content C is reproduced. Then, when the destination content C display process of step S335 ends, an advertisement display process of displaying the advertisement c related to the destination content C in the distribution frame C is executed in step S336, and the advertisement c is displayed or reproduced on the set output device.

Then, in step S304, when the destination has been reached, the content package reproduction process ends, the display end process is performed, and the series of processing ends.

According to the above processing, when the passenger boarding the moving body sets the destination and sets the navigation, the content list is presented according to the destination, and when the passenger selects desired content from the presented content list, the content package with advertisement including the selected destination content and the corresponding advertisement is generated, the content related to the destination based on the content package with advertisement is reproduced, and the advertisement related to the destination content is reproduced.

As a result, while the moving body moves to the destination, the destination content is reproduced, and an advertisement related to the destination content (related to the destination) is displayed, so that the passenger can have a strong image of the destination, enhance the feeling for the destination, and provide real-time advantageous information on the destination and the product or service related to the destination content.

Note that, although FIG. 13 illustrates an example in which one advertisement is selected for one destination content and displayed alternately, a plurality of advertisements may be selected for one destination content. In addition, an advertisement related to the destination content may be reproduced at a timing before the destination content is reproduced, or may be reproduced at a timing before, after, or in the middle of the destination content being reproduced.

### <Configuration Example of Content Reproduction System According to Second Embodiment of Present Disclosure>

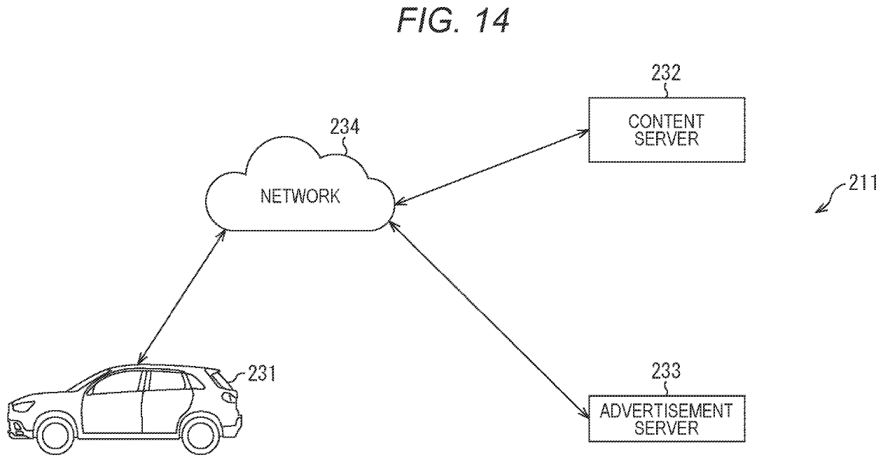

Next, a configuration example of a content reproduction system as a second embodiment of the present disclosure will be described with reference to FIG. 14.

A content reproduction system 211 in FIG. 14 includes a vehicle 231, a content server 232, an advertisement server 233, and a network 234.

Note that the vehicle 231, the content server 232, and the network 234 in the content reproduction system 211 in FIG. 14 have configurations corresponding to the vehicle 31, the content server 32, and the network 33 in the content reproduction system 11 in FIG. 2, and thus the description thereof will be appropriately omitted.

Furthermore, hereinafter, the operation of each configuration of the vehicle 231 and the content server 232 in the content reproduction system 211 in FIG. 14 will be described as the operation by each configuration of the vehicle 31 in FIG. 3 and the content server 32 in FIG. 4.

The advertisement server 233 is implemented by a server computer connected to the network 234 or cloud computing, acquires content organization information including destination content required for generating a content package, supplied from the content server 232, selects and gives an advertisement corresponding to the destination content included in the acquired content organization information, and supplies the advertisement to the content server 232.

Therefore, in the content reproduction system of FIG. 14, the content server 232 generates a content package with advertisement in association with the destination content and distributes the content package to the vehicle 231.

### <Configuration Example of Advertisement Server>

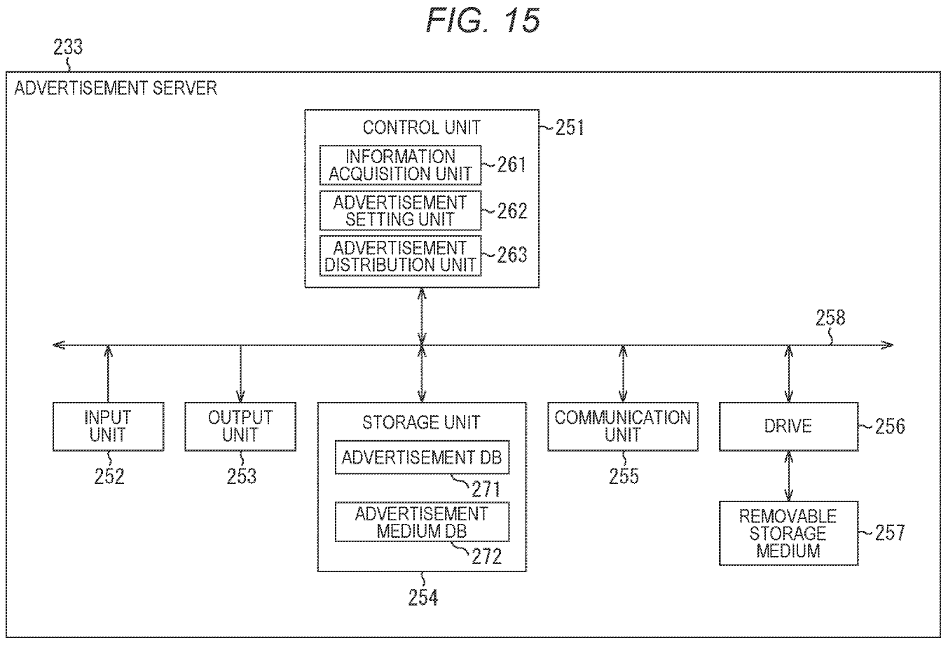

Next, a configuration example of the advertisement server 233 will be described with reference to FIG. 15.

The advertisement server 233 includes a control unit 251, an input unit 252, an output unit 253, a storage unit 254, a communication unit 255, a drive 256, and a removable storage medium 257, and is connected to each other via a bus 258, and can transmit and receive data and programs.

Note that the control unit 251, the input unit 252, the output unit 253, the storage unit 254, the communication unit 255, the drive 256, the removable storage medium 257, and the bus 258 have configurations corresponding to the control unit 101, the input unit 102, the output unit 103, the storage unit 104, the communication unit 105, the drive 106, the removable storage medium 107, and the bus 108 in the content server 32 in FIG. 4, respectively, and thus, detailed description thereof is omitted.

The advertisement server 233 in FIG. 15 is different from the content server 32 (232) in FIG. 4 in that the control unit 251 includes an information acquisition unit 261, an advertisement setting unit 262, and an advertisement distribution unit 263, and an advertisement DB 271 and an advertisement medium DB 272 are stored in storage unit 254.

The information acquisition unit 261 controls the communication unit 255 to acquire information of destination content (or related content) for generating the content package with advertisement transmitted from the content server 232, and content organization information including reproduction timing of the destination content and various presentation settings.

On the basis of on the content organization information acquired by the information acquisition unit 261, the advertisement setting unit 262 accesses the advertisement medium DB 272 of the storage unit 254, and reads advertisement medium data including information indicating a feature of destination content as an advertisement medium.

The advertisement setting unit 262 accesses the advertisement DB 271 of the storage unit 254, searches for an advertisement having a corresponding feature on the basis of information indicating a feature as an advertisement medium included in advertisement medium data corresponding to the read destination content, and selects the searched advertisement as an advertisement related to the destination content.

The advertisement distribution unit 263 generates a list of advertisements selected as advertisements related to destination content by the advertisement setting unit 262 as an advertisement list, and transmits the advertisement list to the content server 232.

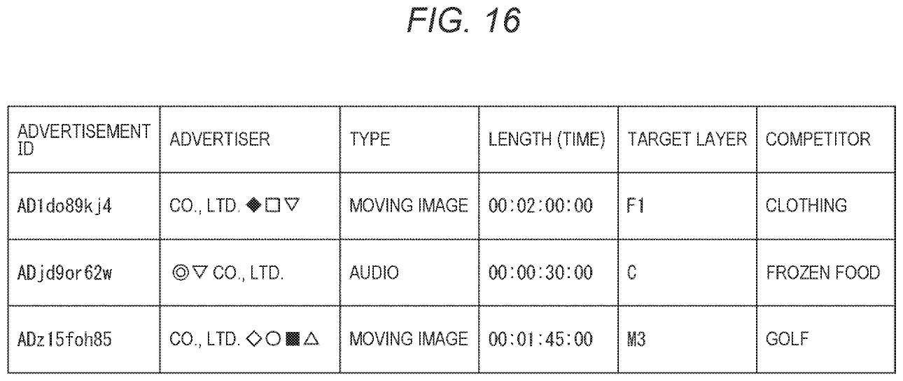

The advertisement DB 271 is a database (DB) including advertisement data which is information indicating a feature as an advertisement for each advertisement. Note that the advertisement DB 271 will be described later in detail with reference to FIG. 16.

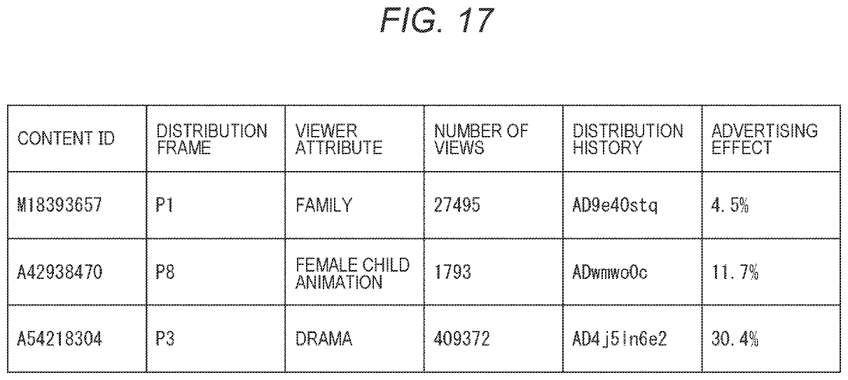

The advertisement medium DB 272 is a database (DB) including advertisement medium data indicating a feature as an advertisement medium for each content (destination content). Note that the advertisement medium DB 272 will be described later in detail with reference to FIG. 17.

That is, the advertisement setting unit 262 searches the advertisement medium DB 272 for advertisement medium data of each piece of destination content included in the content organization information, searches the advertisement DB 271 for an advertisement having a feature included in the searched advertisement medium data and a corresponding feature, and selects the advertisement as an advertisement related to the destination content.

Then, the advertisement distribution unit 263 generates an advertisement list by listing advertisements related to the destination content selected in this way, and transmits the advertisement list to the content server 232.

In this case, the content setting unit 112 of the content server 232 (32) organizes the content data 123 and the advertisement data 124 on the basis of the content organization information of the destination content and the advertisement list, and generates the content package with advertisement on the basis of the organization result.

In addition, the content setting unit 112 stores the destination content used for generating the content package with advertisement in the viewing history 125 of the storage unit 104.

The content distribution unit 113 controls the communication unit 105 to transmit the generated content package with advertisement to the vehicle 31.

### <Configuration Example of Advertisement DB>

Next, a configuration example of the advertisement DB 271 will be described with reference to FIG. 16.

The advertisement DB 271 is a database including advertisement data which is information indicating each feature of each advertisement.

More specifically, as illustrated in FIG. 16, the advertisement DB 271 includes an advertisement ID, an advertiser, a type, a length (time), a target layer, and information of competitor.

The advertisement ID is an identifier for identifying each advertisement, and is expressed by, for example, an alphabet and a numerical value. The advertiser is information indicating a name of an association or an organization that contributes to each advertisement or an individual. The type is information indicating the type of advertisement, and is, for example, information indicating whether the advertisement is a moving image, audio, a still image, or the like.

The length (time) is information indicating a reproduction time of the advertisement. However, the still image is described as “-” because the reproduction time is not defined although not illustrated. In the case of a slide show in which a plurality of still images is repeatedly displayed, one loop is regarded as a reproduction time.

The target layer is information indicating a customer layer to be a target of advertisement, and is classified into, for example, a C layer, a T layer, an M1 layer to an M3 layer, an F1 layer to an F3 layer, and the like in a case where the target layer is indicated by age classification.

Here, the C layer (Child, Kids) indicates a customer layer of men and women aged 4 to 12 years old, the T layer (Teen-age) indicates a customer layer of men and women aged 13 to 19 years old, the M1 layer (Male-1) indicates a customer layer of men aged 20 to 34 years old, the M2 layer (Male-2) indicates a customer layer of men aged 35 to 49 years old, and the M3 layer (Male-3) indicates a customer layer of men aged 50 or more. Furthermore, the F1 layer (Female-1) indicates a customer layer of women aged 20 to 34 years old, the F2 layer (Female-2) indicates a customer layer of women aged 35 to 49 years old, and the F3 layer (Female-3) indicates a customer layer of women aged 50 or more.

The competition indicates a competition field of a product or a service to be an advertisement target for each advertisement. For example, as illustrated in FIG. 16, the competition indicates information of a field in which products or services are competing, such as clothing, frozen food, and golf.

In FIG. 16, “AD1do89kj4”, “ADjd9or62w”, and “Adz15foh85” are indicated as the advertisement IDs from the top.

Further, the advertisement with the advertisement ID “AD1do89kj4” indicates that the advertiser is “Co., Ltd. ♦□∇”, the type is “moving image”, the length (time) is 2 minutes, the target layer is “F1”, and the competitor is “clothing”.

In addition, the advertisement with the advertisement ID “ADjd9or62w” indicates that the advertiser is “⊙∇ Co., Ltd.”, the type is “audio”, the length (time) is 30 seconds, the target layer is “C”, and the competitor is “frozen food”.

Further, the advertisement with the advertisement ID “Adz15foh85” indicates that the advertiser is “Co., Ltd. ⋄◯▪Δ”, the type is “moving image”, the length (time) is 1 minute 45 seconds, the target layer is “M3”, and the competitor is “golf”.

As described above, the advertisement DB 271 is a database of advertisement data which is information indicating a feature of each advertisement. Therefore, by using the advertisement DB 271 and the advertisement medium DB 272, an advertisement (content having the same features as an advertisement medium, being similar to each other, and being highly related or correlated to each other) having information common to a feature as an advertisement medium for each destination content is searched, and thus an advertisement having a relationship with the destination content (having high relevance or correlation) is selected.

### <Configuration Example of Advertisement Medium DB>

Next, a configuration example of the advertisement medium DB 272 will be described with reference to FIG. 17.

The advertisement medium DB 272 is a database (DB) including advertisement medium data indicating a feature as an advertisement medium for each content.

More specifically, as illustrated in FIG. 17, the advertisement medium DB 272 includes a content ID, a distribution frame, a viewer attribute, the number of views, a distribution history, and an advertising effect.

The content ID is an identifier for identifying the content, and is expressed by, for example, an alphabet and a numerical value.

The distribution frame is information for specifying an advertisement frame set in association with each content, and is, for example, information indicating distribution timings such as before the start of reproduction of the content, in the middle of the reproduction time, and after the end of reproduction in an output device in which a movie or music is reproduced in the case of a content having a length (time) such as a movie or music.

The viewer attribute is information that classifies main viewers of the content, and is classified into, for example, “family” indicating that a family layer is a target viewer, “female child animation” indicating that a female child who preferably views animation is a target viewer, “drama” indicating that a viewer who preferably views drama is a target viewer, and the like.

The number of views is information indicating the number of times the content has been viewed so far, and as the number of views is larger, the content can be regarded as having a higher advertising effect.

The distribution history is information of an advertisement ID indicating an advertisement distributed as a related advertisement when the content is distributed in the past.

The advertising effect is information indicating a rate of change in sales or demand of a product or service in which an advertisement selected as an advertisement related to content is advertised before and after being distributed.

In the case of FIG. 17, “M18393657”, “A42938470”, and “A54218304” are written as the content IDs from the top.

Further, the content with the content ID of “M18393657” indicates that the distribution frame is “P1”, the viewer attribute is “family”, the number of times of viewing is 27495 times, the advertisement ID of the advertisement distributed together with the content in the past as the distribution history is “AD9e40stq”, and the advertising effect is “4.5%”.

Further, the content with the content ID of “A42938470” indicates that the distribution frame is “P8”, the viewer attribute is “female child animation”, the number of times of viewing is 1793 times, the advertisement ID of the advertisement distributed together with the content in the past as the distribution history is “ADwmwo0c”, and the advertising effect is “11.7%”.

Further, the content with the content ID of “A54218304” indicates that the distribution frame is “P3”, the viewer attribute is “drama”, the number of times of viewing is 409372 times, the advertisement ID of the advertisement distributed together with the content in the past as the distribution history is “AD4j51n6e2”, and the advertising effect is “30.4%”.

As described above, the advertisement medium DB 272 is a database of advertisement medium data which is information indicating a feature as an advertisement medium for each content (destination content). Therefore, by using the advertisement DB 271 and the advertisement medium DB 272, an advertisement (advertisement having identical features, similar features, and high relationship and correlation as advertisement medium) having information common to a feature as an advertisement medium for each destination content is searched, and thus an advertisement having a relationship with the destination content (having high relevance or correlation) is selected.

### <Content Reproduction Process by Content Reproduction System in FIG. 2>

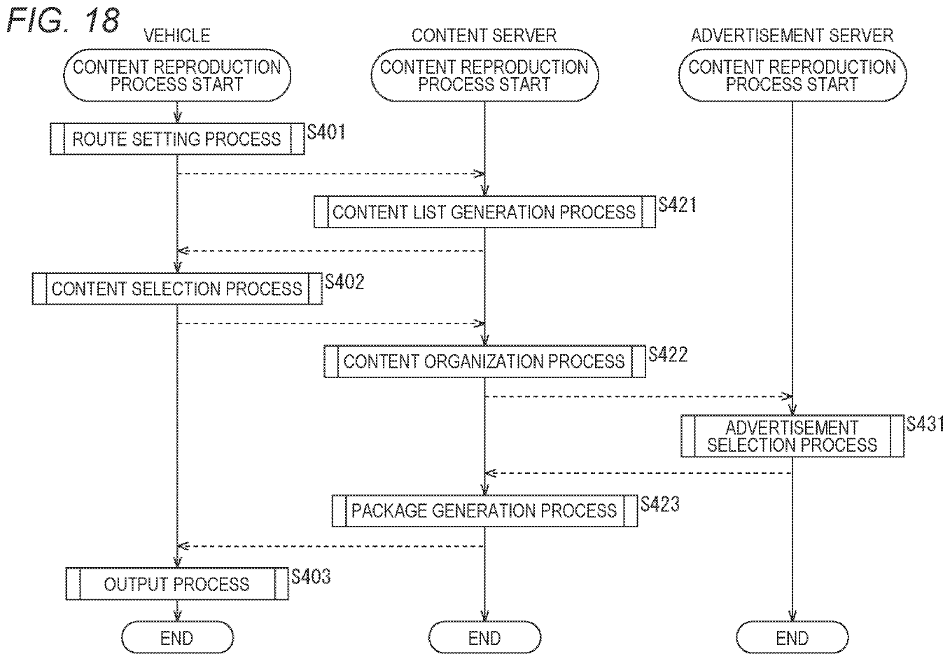

Next, a content reproduction process by the content reproduction system 211 in FIG. 14 will be described with reference to a flowchart in FIG. 18.

Note that steps S401, S402, and step S421 are similar to steps S101, S102, and step S121 in the flowchart of FIG. 7, and thus description thereof is omitted.

In step S401, a route from a departure place to a destination is set, and travel information based on the set route is generated. In step S421, a content list that is a list of content related to the destination is generated in association with the destination of the travel information. In step S402, when content configuration information is generated on the basis of a selection result of destination content desired to be reproduced, the processing proceeds to step S422.

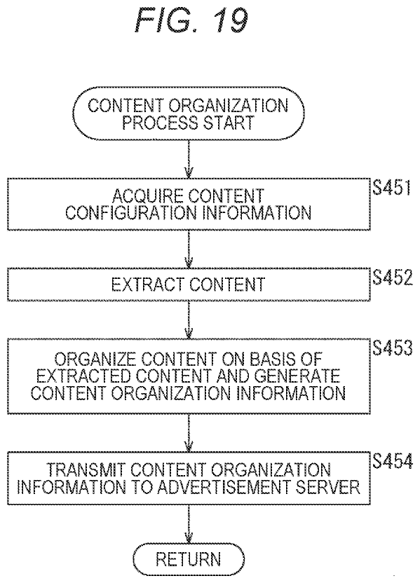

In step S422, the content server 232 executes a content organization process, and generates content organization information by organizing destination content desired to be reproduced on the basis of the content configuration information, and transmits the content organization information to the advertisement server 233. Note that the content organization process will be described later in detail with reference to the flowchart of FIG. 19.

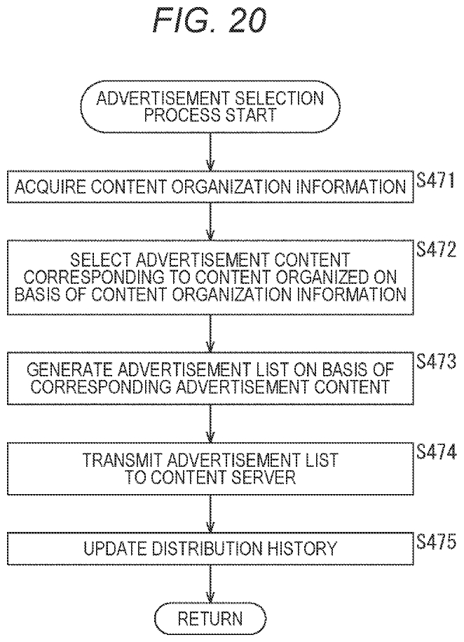

In step S431, the advertisement server 233 executes the advertisement selection process, selects an advertisement related to content to be reproduced on the basis of the content organization information, generates an advertisement list which is a list of the selected advertisement, and transmits the advertisement list to the content server 232. Note that the advertisement selection process will be described later in detail with reference to the flowchart of FIG. 20.

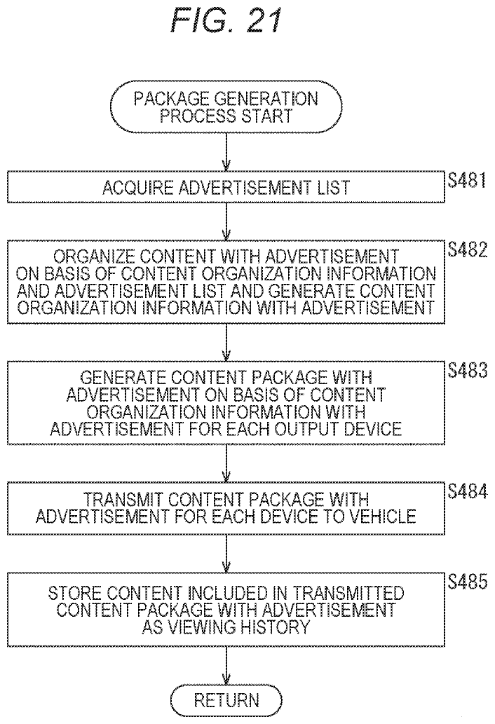

In step S423, the content server 232 executes the package generation process, organizes the destination content desired to be reproduced and the advertisement on the basis of the content organization information and the advertisement list, packages the organization result to generate the content package with advertisement, and transmits the content package with advertisement to the vehicle 31. Note that the package generation process will be described later in detail with reference to the flowchart of FIG. 21.

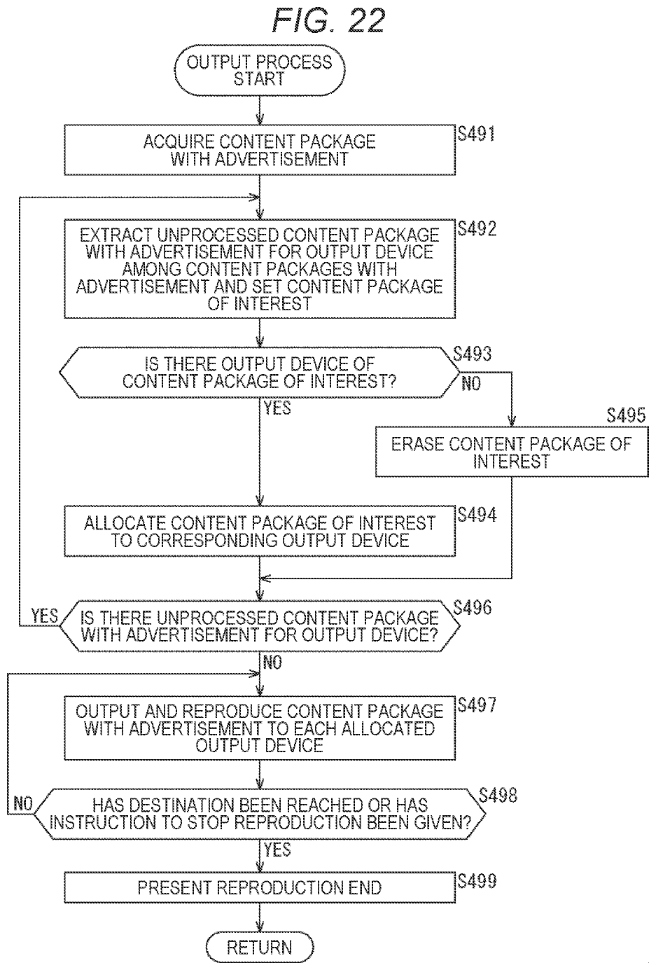

Then, in step S403, the vehicle 31 executes the output process, and reproduces the content package with advertisement in which the destination content desired to be reproduced and the advertisement related to the destination content are packaged in the content list. Note that the output process will be described later in detail with reference to the flowchart of FIG. 22.

According to the above processing, when the passenger sets a destination and sets navigation, a content list is presented according to the destination, and when destination content desired to be reproduced is selected from a content list related to the presented destination, a content package with advertisement including advertisement data having a relationship between the selected destination content and the destination content is generated. Then, the destination content related to the destination and the advertisement data related to the destination content are reproduced on the basis of the content package with advertisement.

As a result, the destination content is reproduced while the passenger is moving to the destination and an advertisement related to the destination content is displayed, so that the passenger can have a strong image of the destination, enhance the feeling for the destination, and provide real-time advantageous information for a product or service related to the destination.

### <Content Organization Process in Flowchart of FIG. 18>

Next, the package generation process in the flowchart of FIG. 18 will be described with reference to the flowchart of FIG. 19.

In step S451, the content distribution unit 113 controls the communication unit 105 to acquire the content configuration information transmitted from the vehicle 231 via the network 234.

In step S452, the content distribution unit 113 extracts content included in the acquired content configuration information.

In step S453, the content distribution unit 113 organizes the extracted content and generates content organization information. The content organization information is information in which the content when the content package is finally generated is organized, and includes information indicating the reproduction timing and order, and the presentation setting in association with the content ID of the content constituting the content package.

In step S454, the content distribution unit 113 controls the communication unit 105 to transmit the content organization information to the advertisement server 233 via the network 234, and ends the processing.

Through the above processing, the content organization information indicating the reproduction timing and order, and the presentation setting, which are configured in association with the content ID of the content in which the content requested to be distributed is reproduced and selected by the passenger of the vehicle 231, is transmitted to the advertisement server 233.

### <Advertisement Selection Process in Flowchart of FIG. 18>

Next, the advertisement selection process in the flowchart of FIG. 18 will be described with reference to the flowchart of FIG. 20.

In step S471, the information acquisition unit 261 of the advertisement server 233 controls the communication unit 255 to acquire the content organization information supplied from the content server 232 via the network 234.

In step S472, the advertisement setting unit 262 selects an advertisement corresponding to the organized content on the basis of the content organization information.

More specifically, the advertisement setting unit 262 accesses the advertisement medium DB 272 stored in the storage unit 254, and extracts the advertisement medium data of the content ID of the content included in the content organization information.

For example, in a case where the content organization information includes the content specified by “A4293870” as the content ID, the advertisement setting unit 262 extracts advertisement medium data of which content ID is “A4293870” in the second row from the top in the drawing from the advertisement medium DB 272 in FIG. 17.

Furthermore, the advertisement setting unit 262 extracts, for example, information of a viewer attribute as information indicating a feature as an advertisement medium of content included in the extracted advertisement medium data. In the case of the advertisement medium data with the content ID of “A4293870”, information of “female child animation” is extracted as the viewer attribute.

Then, the advertisement setting unit 262 accesses the advertisement DB 271 and selects an advertisement serving as a target layer corresponding to the information of the viewer attribute as an advertisement related to the content.

That is, in the case of the content with the content ID “A4293870”, the viewer attribute is “female child animation”, and thus, the advertisement setting unit 262 selects an advertisement with the advertisement ID “ADjd9or62w”, in which the target layer corresponding to female children is the C layer (Child, Kids) (customer layer of 4 to 12 years old), as the advertisement related to the content.

That is, among the advertisements registered in the advertisement DB 271, an advertisement whose feature as an advertisement matches (advertisement similar to or having relevance and correlation with) the feature as an advertisement medium of the destination content is selected as an advertisement related to the destination content.

Since the destination content is content related to the destination (highly related or correlated), it can be said that an advertisement related to the destination content is an advertisement related to the destination (highly related or correlated).

Note that, in a case where the content ID is “A4293870” in the advertisement medium DB 272, the advertisement setting unit 262 may select an advertisement whose advertisement ID registered as a distribution history is “ADwmwo0c”.

The advertisement setting unit 262 selects the related advertisement with respect to all the destination contents included in the content organization information, and extracts the corresponding advertisement ID.

In step S473, the advertisement setting unit 262 generates, as an advertisement list, a list including advertisement IDs that identify selected advertisements for all pieces of content included in the content organization information.

In step S474, the advertisement distribution unit 263 controls the communication unit 255 to transmit the generated advertisement list to the content server 232 via the network 234.

In step S475, the advertisement setting unit 262 updates the distribution history in the advertisement medium DB 272 on the basis of the generated advertisement list, and ends the processing. That is, since the advertisement corresponding to the destination content listed in the advertisement list is an advertisement to be reproduced when the destination content is reproduced, the advertisement is recorded as a distribution history.

Through the above processing, an appropriate advertisement is selected for each content on the basis of the content organization information, and an advertisement list in which advertisement IDs of the selected advertisements are listed is transmitted to the content server 232.

### <Package Generation Process in Flowchart of FIG. 18>

Next, the package generation process in the flowchart of FIG. 18 will be described with reference to the flowchart of FIG. 21.

In step S481, the information acquisition unit 111 of the content server 232 controls the communication unit 105 to acquire the advertisement list transmitted from the advertisement server 233 via the network 234.

In step S482, the content distribution unit 113 organizes the content with advertisement on the basis of the content organization information and the advertisement list, and generates the content organization information with advertisement.

In step S483, the content distribution unit 113 reads the corresponding content data 123 and advertisement data 124 on the basis of the content organization information with advertisement, and generates a content package with advertisement by packaging the content data with each output device.

Here, the content with advertisement is, for example, as indicated by destination content A and advertisement a in FIG. 13, integrated content in which corresponding advertisement a is added to destination content A. The advertisement b corresponding to the destination content B and the advertisement c corresponding to the destination content C are also the content with advertisement.

In addition, the organization information of the plurality of pieces of content with advertisement is the content organization information with advertisement. The content organization information with advertisement includes, for each piece of content with advertisement, a content ID of the content and an advertisement ID of the advertisement, and is information including a timing and an order in which each advertisement corresponding to the content is reproduced and a presentation setting. The presentation setting of the advertisement includes information designating how to display the advertisement with which output device indicated as the distribution frames A to C in the advertisement display process of FIG. 13.

Then, the content distribution unit 113 generates reproduction control information to be used when the content package with advertisement is reproduced in the vehicle 31 on the basis of the content organization information, and packages the reproduction control information together with the corresponding content data 123 and the advertisement data 124 to generate the content package with advertisement.

In step S484, the content distribution unit 113 controls the communication unit 105 to transmit (distribute) the generated content package with advertisement for each output device to the vehicle 231.

In step S485, the content distribution unit 113 updates the viewing history 125 of the storage unit 104 on the basis of the generated content package with advertisement for each output device. That is, the content included in the content package with advertisement is regarded as being reproduced and viewed in the vehicle 31, and is updated by adding new information to the viewing history 125.

Through the above processing, the content package with advertisement of each device is transmitted (distributed) to the vehicle 231 on the basis of the content configuration.

### <Output Process in Flowchart of FIG. 18>

Next, the output process in the flowchart of FIG. 18 will be described with reference to the flowchart of FIG. 22.

In step S491, the content reproduction unit 63 controls the communication unit 55 to acquire the content package with advertisement transmitted from the content server 232 via the network 234.

In step S492, the content reproduction unit 63 extracts an unprocessed content package with advertisement for an output device from the acquired content package with advertisement, and sets the content package with advertisement as a content package of interest which is a content package of interest as a processing target.

In step S493, the content reproduction unit 63 determines whether or not there is a set output device on the basis of the reproduction control information included in the content package of interest.

In step S493, in a case where there is an output device set as the content package of interest, the processing proceeds to step S494.

In step S494, the content reproduction unit 63 allocates the content package of interest so that the content package of interest can be reproduced on the corresponding output device.

On the other hand, in step S493, in a case where there is no output device set as the content package of interest, the processing proceeds to step S495.

In step S495, the content reproduction unit 63 erases the content package with advertisement set as the target content package.

In step S496, the content reproduction unit 63 determines whether or not there is an unprocessed content package with advertisement for an output device among the acquired content packages with advertisement.

In step S496, in a case where there is an unprocessed content package with advertisement for an output device, the processing returns to step S492. That is, the processing of steps S492 to S496 is repeated until there is no unprocessed content package for the output device.

Then, in step S496, in a case where there is no unprocessed content package with advertisement for an output device, the processing proceeds to step S497.

In step S497, the content reproduction unit 63 outputs and reproduces the content package with advertisement from the output devices to which the content package with advertisement is allocated. At this time, the content reproduction unit 63 applies, to the content and the advertisement, processing corresponding to the reproduction timing and order of the content and the advertisement in the content with advertisement and the presentation setting based on the reproduction control information included in each content package with advertisement, and causes the content and the advertisement to be output from the designated output device.

That is, since the content with advertisement is reproduced, for example, as illustrated in FIG. 13, after the destination content A is reproduced, the advertisement a related to the destination content A is reproduced in the distribution frame A. Further, after the advertisement a is reproduced, the destination content B is reproduced, and thereafter, the advertisement b related to the destination content B is reproduced in the distribution frame B. Further, after the advertisement b is reproduced, the destination content C is reproduced, and then the advertisement c related to the destination content C is reproduced in the distribution frame C.

In step S498, the content setting unit 62 determines whether or not the destination has been reached or whether or not the instruction to stop the reproduction has been given by the operation input of the input unit 52.

In step S498, in a case where the destination has not been reached and the instruction to stop the reproduction is not given by the operation input of the input unit 52, the processing returns to step S497. That is, in a case where the destination has not been reached, and the instruction to stop the reproduction is not given by operating the input unit 52, the processing of steps S497 and S498 is repeated, and the processing of outputting and reproducing the content package with advertisement from the output devices allocated to the respective content packages with advertisement is repeated.

Then, in a case where it is determined in step S498 that the destination has been reached or the input unit 52 has been operated and an instruction to stop reproduction has been given, the processing proceeds to step S499.

In step S499, the content setting unit 62 stops the reproduction of the content package and controls the display unit 71 and the audio output unit 72 to present the end of the reproduction by the image and the audio, and ends the processing.

By the above series of processing, when a destination is set, a content list including destination content related to the destination or related content is generated, destination content desired to be reproduced is selected on the basis of the content list, an advertisement related to the selected destination content is selected, and a content package with advertisement including the content and the advertisement related to the content is generated, distributed to the vehicle 231, and reproduced.

As a result, the destination content related to the destination and the advertisement related to the destination content can be reproduced in the vehicle 31 along with the movement from the departure place to the destination.

As a result, by reproducing and presenting the content related to the destination and the advertisement related to the content to the passenger during the movement to the destination, it is possible to strongly impart an image of the destination before the passenger arrives at the destination, it is possible to enhance the feeling for the destination, and it is possible to provide the advantageous information of the product, the service, or the like related to the destination.

### 3. Application Example of Second Embodiment

<Content Reproduction System for Reproducing Content Related to Surroundings of Home which is Destination, or Content Related to Present Departure Place which is Destination on Outward Way, on Return Way>

In the above description, an example has been described in which content according to a destination is searched for as destination content, a content list is generated, content organization information including destination content selected from the content list is generated, an advertisement list is set on the basis of the content organization information, content and advertisements are organized on the basis of the content organization information and the advertisement list, and a content package with advertisement is generated and reproduced on the basis of an organization result.

However, although the above-described processing is processing in the outward way toward the destination, similar processing may be applied to the return way.

### <Return Way Content Reproduction Process by Content Reproduction System in FIG. 14>

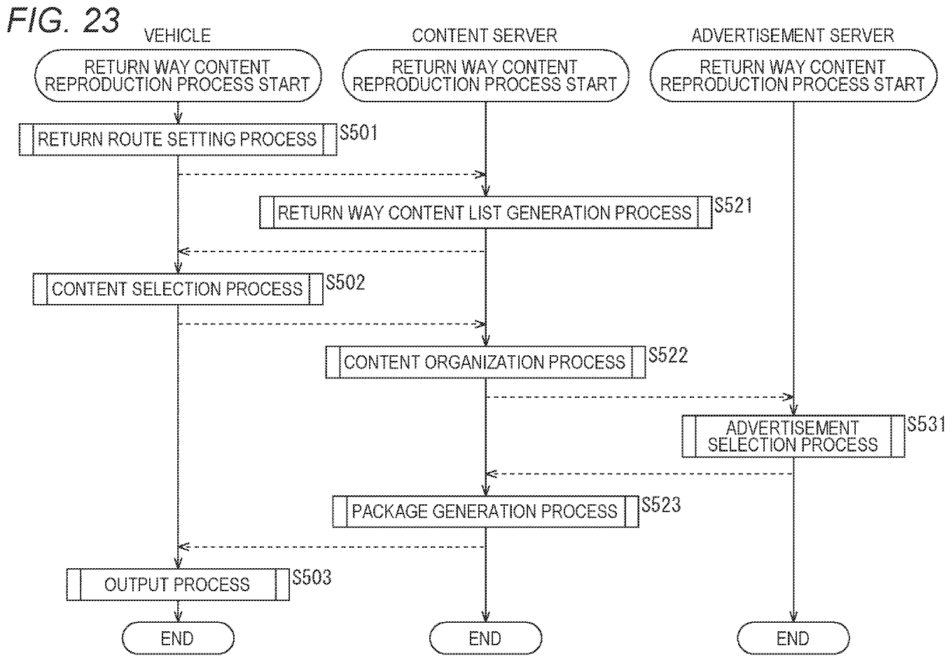

Next, a return way content reproduction process by the content reproduction system 211 in FIG. 14 will be described with reference to a flowchart in FIG. 23.

Note that the processing of steps S502 and S503, steps S522 and S523, and step S531 is similar to steps S402 and S403, steps S422 and S423, and step 431 in the flowchart of FIG. 18, and thus description thereof is omitted.

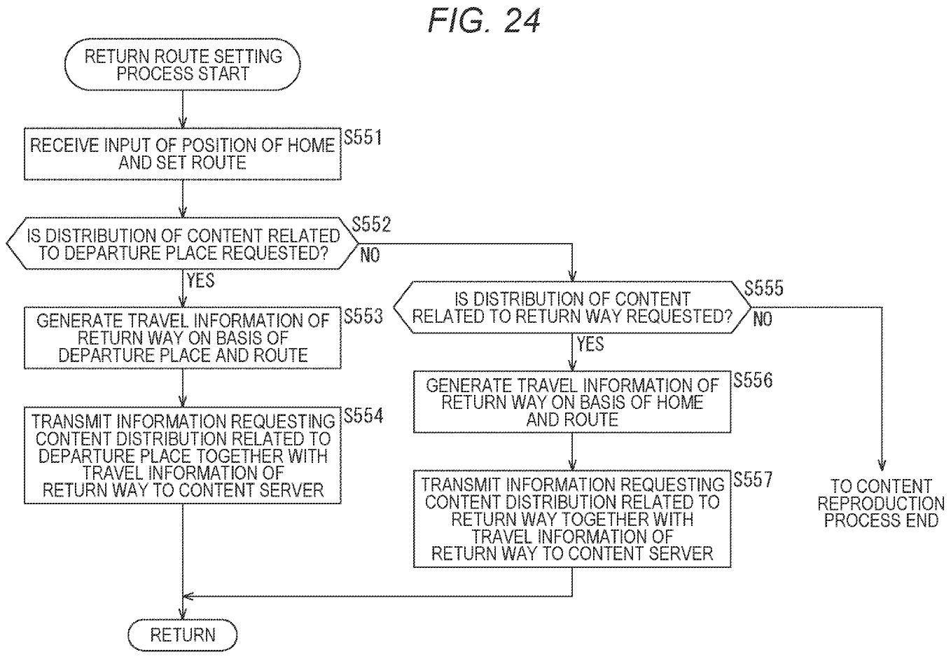

That is, in step S501, the return route setting process is executed, a route from the destination on the outward way which is the current departure place to the home which is the destination on the return way is set, and the travel information based on the set route is generated. At this time, information indicating whether it is desired to reproduce content related to the surroundings of the home, which is the destination on the return way, or whether it is desired to reproduce content related to the current departure place, which is the destination on the outward way, is transmitted to the content server 232 together with the travel information. Note that the return route setting process will be described later in detail with reference to the flowchart of FIG. 24.

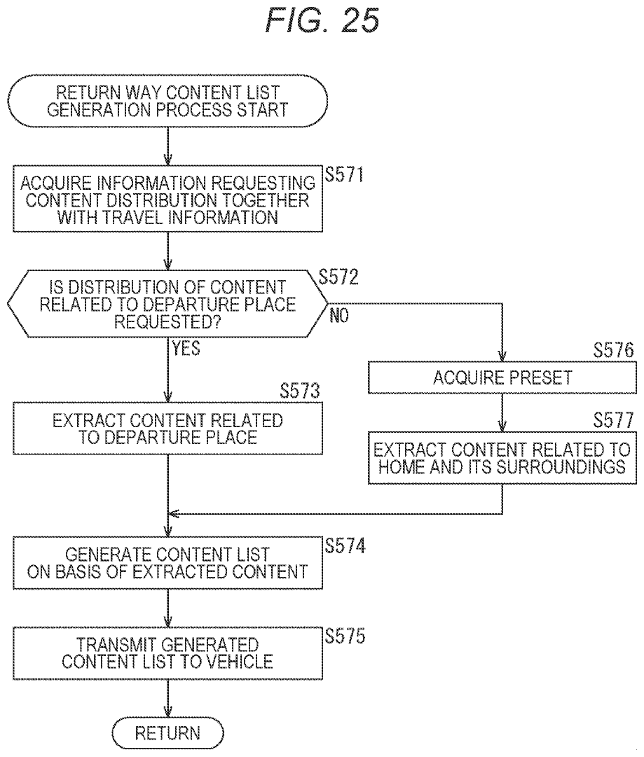

Then, in step S521, the return way content list generation process is executed, and a return way content list, which is a list of content corresponding to the surroundings of the home, which is the destination on the return way of the travel information, or the current departure place, which is the destination of the outward way, is generated. Note that the return way content list generation process will be described later in detail with reference to the flowchart of FIG. 25.

Furthermore, since content related to the surroundings of the home is the same regardless of the departure place, the content may be stored in advance as preset information.

According to the above processing, when the passenger sets the return way and sets the navigation, a content list related to the destination on the outward way which is the current departure place or a content list related to the surroundings of the home which is the destination on the return way is presented, and when content desired to be reproduced is selected from the presented content list, a content package with advertisement including the selected content and corresponding advertisement data is generated, the destination content based on the content package with advertisement is reproduced, and the advertisement data related to the destination content is reproduced.

As a result, the passenger can go home while immersing in the afterglow spent in the current departure place (destination of the outward way) by reproducing the content and advertisement related to the current departure place which is the destination in the outward way during the movement to the home on the return way. Furthermore, by reproducing content and advertisements related to the surroundings of the home, which is a destination of the return way, it is possible to return home while recalling the surroundings of the home.

### <Return Route Setting Process in Flowchart of FIG. 23>

Next, a return route setting process which is a process of step S501 in the flowchart of FIG. 23 will be described with reference to the flowchart of FIG. 24.

In step S551, when receiving the input of the position of the home, which is the destination of the return way, by operating the input unit 52, the route setting unit 61 of the vehicle 31 sets a route to the home, which is the destination of which the input is received, from the current location, which is the departure place detected by the detection unit 59. Note that the home position may be preset information.

In step S552, the route setting unit 61 controls the display unit 71 and the audio output unit 72 of the output unit 53 to output, as an image and audio, information prompting the input of information indicating whether or not the distribution of the content related to the departure place (related to the current location) as the destination of the outward way is requested until the user arrives at the home as the destination of the return way. Then, the route setting unit 61 determines whether or not the input unit 52 has been operated and information requesting distribution of content related to the departure place has been input.

In step S552, in a case where the input unit 52 is operated and it is determined that the distribution of the content related to the departure place is requested, the processing proceeds to step S553.

In step S553, the route setting unit 61 generates return way travel information in which the departure place information and the set route are collected on the basis of the information on the departure place and the set route.

In step S554, the route setting unit 61 controls the communication unit 55 to transmit information requesting content distribution related to the departure place, which is the current location, together with the return way travel information to the content server 232 via the network 234, and ends the processing.

On the other hand, in step S552, in a case where the input unit 52 is operated and it is determined that the distribution of the content related to the departure place is not requested, the processing proceeds to step S555.

In step S555, the route setting unit 61 controls the display unit 71 and the audio output unit 72 of the output unit 53 to output, as an image and audio, information prompting the input of information indicating whether or not the distribution of the content related to the return way (related to the surroundings of the home which is the destination of the return way) is requested before the arrival at the home which is the destination of the return way. Then, the route setting unit 61 determines whether or not the input unit 52 is operated and information for requesting distribution of content related to the surroundings of the home as the destination is input.

In step S555, in a case where the input unit 52 is operated and it is determined that distribution of content related to the surroundings of the home as the destination is requested, the processing proceeds to step S556.

In step S556, the route setting unit 61 generates the return way travel information in which the information about the surroundings of the home, which is the destination, and the set route are collected.

In step S557, the route setting unit 61 controls the communication unit 55 to transmit information requesting content distribution related to the surroundings of the home, which is the destination, to the content server 32 together with the return way travel information via the network 33, and ends the processing.

Note that, in step S555, in a case where the distribution of the content related to the surroundings of the home, which is the destination, is not requested, the content reproduction process ends.

That is, by the above processing, any one of the information of the current location as the departure place, the travel information including the route from the current location as the departure place to the home as the destination, and the information requesting the distribution of the content related to the departure place, or the information of the home as the destination, the travel information including the route from the current location as the departure place to the destination, and the information requesting the distribution of the content related to the return way (related to the surroundings of the home as the destination) is transmitted to the content server 232. Note that the information requesting the distribution of the content includes identification information for identifying the vehicle 31.

### <Return Way Content List Generation Process in Flowchart of FIG. 23>

Next, a return way content list generation process in the flowchart of FIG. 23 will be described with reference to the flowchart of FIG. 25.

In step S571, the information acquisition unit 111 of the content server 32 controls the communication unit 105 to acquire the travel information transmitted from the vehicle 31 via the network 33, and the information requesting the distribution of the content related to the departure place or the information requesting the distribution of the content related to the return way. At this time, the information acquisition unit 111 extracts information for identifying the vehicle 31 from the information requesting the distribution of the content.

In step S572, the content setting unit 112 determines whether or not the distribution of the content related to the departure place is requested.

In a case where it is determined in step S572 that the distribution of the content related to the departure place is requested, the processing proceeds to step S573.

In step S573, on the basis of the content DB 121 and the travel destination DB 122, the content setting unit 112 extracts the departure place content which is content related to the departure place (related to a current location which is a departure place) included in the travel information acquired by information acquisition unit 111.

In step S574, the content setting unit 112 generates a content list as a list of content on the basis of the extracted departure place content.

In step S575, the content setting unit 112 controls the communication unit 105 to transmit the generated content list to the vehicle 31 corresponding to the information for identifying the vehicle 31 included in the information requesting the distribution of the content via the network 234.

On the other hand, in a case where it is determined in step S572 that the distribution of the content related to the departure place is not requested, it is regarded that the distribution of the content related to the return way (the content related to the surroundings of the home which is the destination) is requested, and the processing proceeds to step S576.

In step S576, the content setting unit 112 reads in advance the preset information of the information of the content related to the return way stored in the storage unit 104.

In step S577, the content setting unit 112 extracts the information of the content related to the return way from the read preset information, and the processing proceeds to step S574.

Note that, here, it is assumed that the content related to the return way is preset in advance, but in a case where the content related to the return way is not preset, the content setting unit 112 extracts content related to the surroundings of the home, which is the return way.

That is, in this case, in step S574, the content setting unit 112 generates a content list as a list of content on the basis of the extracted content related to the return way.

According to the above processing, when the passenger sets the return way and sets the navigation, the content list of the departure place content related to the current location which is the departure place and the destination of the outward way or the content list of the return way content related to the surroundings of the home which is the destination of the return way is presented, and when desired content is selected from the presented content list, the content package with advertisement including the selected content and the corresponding advertisement is generated, and the content and the advertisement based on the content package with advertisement are reproduced.

As a result, during the movement to the home on the return way, the passenger reproduces the content and advertisement related to the departure place which is the destination of the outward way and is also the current location, so that the passenger can remember the event at the destination in the outward way which is the travel destination and go home while immersing in the afterglow. In addition, by reproducing content and advertisements related to the surroundings of the home, which is a destination, it is possible to return home while recalling the surroundings of the home.

### 4. Example of Execution by Software

Incidentally, the series of processing described above can be executed by hardware, but can also be executed by software. In a case where the series of processing is executed by software, a program constituting the software is installed from a recording medium into, for example, a computer built into dedicated hardware or a general-purpose computer that is capable of executing various functions by installing various programs, or the like.

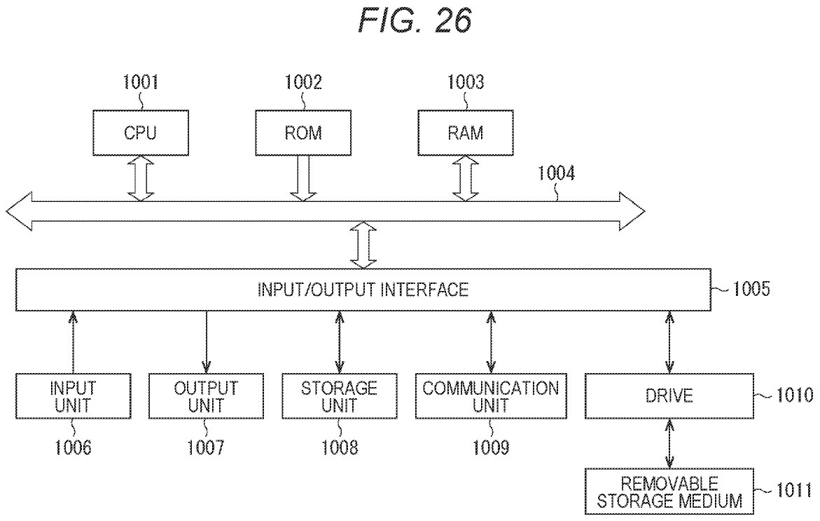

FIG. 26 illustrates a configuration example of a general-purpose computer. This computer includes a central processing unit (CPU) 1001. An input/output interface 1005 is connected to the CPU 1001 via a bus 1004. A read only memory (ROM) 1002 and a random access memory (RAM) 1003 are connected to the bus 1004.

To the input/output interface 1005, an input unit 1006 including an input device such as a keyboard and a mouse by which a user inputs operation commands, an output unit 1007 that outputs a processing operation screen and an image of a processing result to a display device, a storage unit 1008 that includes a hard disk drive and the like and stores programs and various data, and a communication unit 1009 including a local area network (LAN) adapter or the like and executes communication processing via a network represented by the Internet are connected. Furthermore, a drive 1010 that reads and writes data from and to a removable storage medium 1011 such as a magnetic disk (including flexible disk), an optical disk (including compact disc-read only memory (CD-ROM) and digital versatile disc (DVD)), a magneto-optical disk (including Mini Disc (MD)), or a semiconductor memory is connected.

The CPU 1001 executes various processes in accordance with a program stored in the ROM 1002, or a program read from the removable storage medium 1011 such as a magnetic disk, an optical disk, a magneto-optical disk, or a semiconductor memory, installed in the storage unit 1008, and loaded from the storage unit 1008 into the RAM 1003. Furthermore, the RAM 1003 also appropriately stores data necessary for the CPU 1001 to execute various processes, and the like.

In the computer configured as described above, for example, the CPU 1001 loads the program stored in the storage unit 1008 into the RAM 1003 via the input/output interface 1005 and the bus 1004 and executes the program, to thereby perform the above-described series of processing.

The program executed by the computer (CPU 1001) can be provided by being recorded in the removable storage medium 1011 as a package medium or the like, for example. Alternatively, the programs can be provided via a wired or wireless transmission medium such as a local area network, the Internet, or digital satellite broadcasting.

In the computer, the program can be installed in the storage unit 1008 via the input/output interface 1005 by mounting the removable storage medium 1011 to the drive 1010. Furthermore, the program can be received by the communication unit 1009 via a wired or wireless transmission medium and installed in the storage unit 1008. In addition, the program can be installed in the ROM 1002 or the storage unit 1008 in advance.

Note that the program executed by the computer may be a program that executes processing in time series in the order described herein, or a program that executes processing in parallel or at a necessary timing such as when a call is made.

Note that the CPU 1001 in FIG. 26 implements the functions of the control unit 51 in FIG. 3, the control unit 101 in FIG. 4, and the control unit 251 in FIG. 15.

Furthermore, in the present specification, a system is intended to mean assembly of a plurality of components (devices, modules (parts) and the like) and it does not matter whether or not all the components are in the same housing. Therefore, a plurality of devices housed in separate housings and connected via a network, and one device having a plurality of modules included in one housing are both systems.

Note that embodiments of the present disclosure are not limited to the embodiment described above, and various modifications may be made without departing from the scope of the present disclosure.

For example, the present disclosure can have a configuration of cloud computing in which one function is shared by a plurality of devices via a network and processing is performed in cooperation.

Furthermore, each step described in the flowchart described above can be carried out by one device or by a plurality of devices in a shared manner.

Moreover, in a case where a plurality of processes is included in one step, the plurality of the processes included in the one step can be performed by one device or by a plurality of devices in a shared manner.

Note that the present disclosure may have the following configurations.

<1> A content distribution system including: a moving body; and a server that distributes content to the moving body, in which
the moving body includes:
a travel destination information processing unit that executes processing according to travel destination information that is information of a travel destination; and
a content reproduction unit that acquires and reproduces the content distributed by the server, and
the server includes
a content distribution unit that selects the content on the basis of the travel destination information and distributes the content to the moving body.

<2> The content distribution system according to <1>, in which
the server further includes:
a content database in which content feature information indicating a feature of each content is stored as a database; and
a location database in which location feature information indicating a feature of each location is stored as a database, and
the content distribution unit searches the location database for the location feature information of a location corresponding to the travel destination information, searches the content database for the content having the content feature information corresponding to the location feature information searched, and distributes the content searched to the moving body.

<3> The content distribution system according to <2>, in which
the content database includes an ID and attribute information of each content as the content feature information,
the location database includes, as the location feature information, an ID, latitude and longitude, and attribute information for each location, and
the content distribution unit searches the location database for location feature information including attribute information of a location corresponding to the travel destination information, searches the content database for the content including attribute information of the content feature information that is same as or similar to the attribute information of the location corresponding to the travel destination information of the location feature information searched, and transmits the content searched to the moving body.

<4> The content distribution system according to <3>, in which
the content distribution unit generates reproduction control information to be used when the content reproduction unit reproduces the content searched, and transmits the reproduction control information to the moving body together with the content searched, and
the content reproduction unit acquires the content and the reproduction control information and reproduces the content on the basis of the reproduction control information.

<5> The content distribution system according to <4>, in which
the content distribution unit packages the content searched together with the reproduction control information to generate a content package, and transmits the content package generated to the moving body, and
the content reproduction unit acquires the content package and reproduces the content included in the content package on the basis of the reproduction control information.

<6> The content distribution system according to <4>, in which
the reproduction control information includes output device information for specifying an output device to be used for reproducing the content, a reproduction timing, an order, and a presentation setting, and
the content reproduction unit performs presentation based on the presentation setting on the content at the reproduction timing and in the order and causes the content to be reproduced using the output device specified by the output device information, the output device information being included in the reproduction control information.

<7> The content distribution system according to <3>, in which
the attribute information in the content feature information of the content database includes a character movie/drama, a sports theme song, and a sightseeing spot image, and
the attribute information in the location feature information of the location database includes a sightseeing spot, a sports venue, an event venue, an amusement, an attraction, and a character.

<8> The content distribution system according to <3>, in which
the travel destination information processing unit sets a route from a current location to the travel destination on the basis of the travel destination information, and
the content distribution unit extracts, from the location database, the location feature information corresponding to a location existing on the route together with a location corresponding to the travel destination information, searches the content database for content having the content feature information relevant with respect to the location feature information of each of the travel destination information extracted and the location existing on the route, and distributes the content searched to the moving body.

<9> The content distribution system according to <8>, in which
the content distribution unit extracts, from the location database, the location feature information corresponding to a location existing within a predetermined distance from the route on the basis of the latitude and longitude of the location feature information together with the location corresponding to the travel destination information, searches the content database for content having the content feature information relevant with respect to the location feature information of each of the travel destination information extracted and the location existing within the predetermined distance from the route, and distributes the content searched to the moving body.

<10> The content distribution system according to any one of <1> to <9>, further including another server different from the server, in which
the content distribution unit transmits the content selected on the basis of the travel destination information to the another server,
the another server includes
an advertisement selection unit that selects an advertisement related to the content on the basis of the content selected on the basis of the travel destination information and transmits the advertisement to the server,
the content distribution unit generates content with advertisement on the basis of the advertisement and the content selected on the basis of the travel destination information, and distributes the content with advertisement to the moving body, and the content reproduction unit reproduces the content with advertisement.

<11> The content distribution system according to <10>, in which
the another server further includes:
an advertisement medium database in which content advertisement medium feature information indicating a feature as an advertisement medium of each content is stored as a database; and
an advertisement database in which advertisement feature information indicating a feature of each advertisement is stored as a database, and
the advertisement selection unit searches the advertisement medium database for the content advertisement medium feature information corresponding to the content transmitted from the server, searches the advertisement database for an advertisement having advertisement feature information related to the content advertisement medium feature information searched, and transmits the advertisement searched to the server.

<12> The content distribution system according to <11>, in which
the advertisement medium database includes an ID and viewer attribute information of each content as the content advertisement medium feature information,
the advertisement database includes, as the advertisement feature information, an ID and target layer information of each advertisement, and
the advertisement selection unit searches the advertisement medium database for content corresponding to an ID of each content transmitted from the server, searches the advertisement database for an advertisement having the target layer information corresponding to the viewer attribute information of the content searched, and transmits the advertisement searched to the server.

<13> The content distribution system according to <12>, in which
the viewer attribute information includes a family, a female child animation, and a drama, and
the target layer information includes classification information of sex and age including a C layer, a T layer, M1 to M3 layers, and F1 to F3 layers.

<14> The content distribution system according to any one of <1> to <13>, in which
when a departure place on an outward way is set as the travel destination information of a return way,
the content distribution unit selects the content on the basis of the travel destination information or information of a current location and distributes the content to the moving body.

<15> The content distribution system according to <14>, in which
the content distribution unit selects the content on the basis of the travel destination information or the information of the current location and distributes the content to the moving body in response to a request from a passenger of the moving body.

<16> The content distribution system according to any one of <1> to <15>, in which
the content includes a video, a game, music, audio, and a still image.

<17> The content distribution system according to any one of <1> to <16>, in which
the moving body includes a vehicle, a ship, and an aircraft.

<18> An operation method of a content distribution system including: a moving body; and a server that distributes content to the moving body,
the moving body including:
a travel destination information processing unit that executes processing according to travel destination information that is information of a travel destination; and
a content reproduction unit that acquires and reproduces the content distributed by the server,
the server including
a content distribution unit that selects the content on the basis of the travel destination information and distributes the content to the moving body,
the operation method including the steps of:
executing, by the travel destination information processing unit, processing according to the travel destination information;
acquiring and reproducing, by the content reproduction unit, the content distributed from the server; and
selecting, by the content distribution unit, the content on the basis of the travel destination information and distributing the content to the moving body.

<19> A program causing,
among computers that control a content distribution system including: a moving body; and a server that distributes content to the moving body,
a computer that controls the moving body to function as:
a travel destination information processing unit that executes processing according to travel destination information that is information of a travel destination; and
a content reproduction unit that acquires and reproduces the content distributed by the server, and
a computer that controls the server to function as
a content distribution unit that selects the content on the basis of the travel destination information and distributes the content to the moving body.

### REFERENCE SIGNS LIST

11 Content reproduction system
31 Vehicle
32 Content server
33 Network
51 Control unit
54 Output unit
61 Route setting unit
62 Content setting unit
63 Content reproduction unit
71 Display unit
72 Audio output unit
101 Control unit
104 Storage unit
111 Information acquisition unit
112 Content setting unit
113 Content distribution unit
121 Content DB
122 Travel destination DB
123 Content data
124 Advertisement data
125 Viewing history
211 Content reproduction system
231 Vehicle
232 Content server sensor unit
233 Advertisement server
234 Network
251 Control unit
254 Storage unit
261 Information acquisition unit
262 Advertisement setting unit
263 Advertisement distribution unit
271 Advertisement DB
272 Advertisement medium DB

1. A content distribution system comprising: a moving body; and a server that distributes content to the moving body, wherein
the moving body includes:
a travel destination information processing unit that executes processing according to travel destination information that is information of a travel destination; and
a content reproduction unit that acquires and reproduces the content distributed by the server, and
the server includes
a content distribution unit that selects the content on a basis of the travel destination information and distributes the content to the moving body.

2. The content distribution system according to claim 1, wherein
the server further includes:
a content database in which content feature information indicating a feature of each content is stored as a database; and
a location database in which location feature information indicating a feature of each location is stored as a database, and
the content distribution unit searches the location database for the location feature information of a location corresponding to the travel destination information, searches the content database for the content having the content feature information corresponding to the location feature information searched, and distributes the content searched to the moving body.

3. The content distribution system according to claim 2, wherein
the content database includes an ID and attribute information of each content as the content feature information,
the location database includes, as the location feature information, an ID, latitude and longitude, and attribute information for each location, and
the content distribution unit searches the location database for location feature information including attribute information of a location corresponding to the travel destination information, searches the content database for the content including attribute information of the content feature information that is same as or similar to the attribute information of the location corresponding to the travel destination information of the location feature information searched, and transmits the content searched to the moving body.

4. The content distribution system according to claim 3, wherein
the content distribution unit generates reproduction control information to be used when the content reproduction unit reproduces the content searched, and transmits the reproduction control information to the moving body together with the content searched, and
the content reproduction unit acquires the content and the reproduction control information and reproduces the content on a basis of the reproduction control information.

5. The content distribution system according to claim 4, wherein
the content distribution unit packages the content searched together with the reproduction control information to generate a content package, and transmits the content package generated to the moving body, and
the content reproduction unit acquires the content package and reproduces the content included in the content package on a basis of the reproduction control information.

6. The content distribution system according to claim 4, wherein
the reproduction control information includes output device information for specifying an output device to be used for reproducing the content, a reproduction timing, an order, and a presentation setting, and
the content reproduction unit performs presentation based on the presentation setting on the content at the reproduction timing and in the order and causes the content to be reproduced using the output device specified by the output device information, the output device information being included in the reproduction control information.

7. The content distribution system according to claim 3, wherein
the attribute information in the content feature information of the content database includes a character movie/drama, a sports theme song, and a sightseeing spot image, and
the attribute information in the location feature information of the location database includes a sightseeing spot, a sports venue, an event venue, an amusement, an attraction, and a character.

8. The content distribution system according to claim 3, wherein
the travel destination information processing unit sets a route from a current location to the travel destination on a basis of the travel destination information, and
the content distribution unit extracts, from the location database, the location feature information corresponding to a location existing on the route together with a location corresponding to the travel destination information, searches the content database for content having the content feature information relevant with respect to the location feature information of each of the travel destination information extracted and the location existing on the route, and distributes the content searched to the moving body.

9. The content distribution system according to claim 8, wherein
the content distribution unit extracts, from the location database, the location feature information corresponding to a location existing within a predetermined distance from the route on a basis of the latitude and longitude of the location feature information together with the location corresponding to the travel destination information, searches the content database for content having the content feature information relevant with respect to the location feature information of each of the travel destination information extracted and the location existing within the predetermined distance from the route, and distributes the content searched to the moving body.

10. The content distribution system according to claim 1, further comprising another server different from the server, wherein
the content distribution unit transmits the content selected on a basis of the travel destination information to the another server,
the another server includes
an advertisement selection unit that selects an advertisement related to the content on a basis of the content selected on a basis of the travel destination information and transmits the advertisement to the server,
the content distribution unit generates content with advertisement on a basis of the advertisement and the content selected on a basis of the travel destination information, and distributes the content with advertisement to the moving body, and
the content reproduction unit reproduces the content with advertisement.

11. The content distribution system according to claim 10, wherein
the another server further includes:
an advertisement medium database in which content advertisement medium feature information indicating a feature as an advertisement medium of each content is stored as a database; and
an advertisement database in which advertisement feature information indicating a feature of each advertisement is stored as a database, and
the advertisement selection unit searches the advertisement medium database for the content advertisement medium feature information corresponding to the content transmitted from the server, searches the advertisement database for an advertisement having advertisement feature information related to the content advertisement medium feature information searched, and transmits the advertisement searched to the server.

12. The content distribution system according to claim 11, wherein
the advertisement medium database includes an ID and viewer attribute information of each content as the content advertisement medium feature information,
the advertisement database includes, as the advertisement feature information, an ID and target layer information of each advertisement, and
the advertisement selection unit searches the advertisement medium database for content corresponding to an ID of each content transmitted from the server, searches the advertisement database for an advertisement having the target layer information corresponding to the viewer attribute information of the content searched, and transmits the advertisement searched to the server.

13. The content distribution system according to claim 12, wherein
the viewer attribute information includes a family, a female child animation, and a drama, and
the target layer information includes classification information of sex and age including a C layer, a T layer, M1 to M3 layers, and F1 to F3 layers.

14. The content distribution system according to claim 1, wherein
when a departure place on an outward way is set as the travel destination information of a return way,
the content distribution unit selects the content on a basis of the travel destination information or information of a current location and distributes the content to the moving body.

15. The content distribution system according to claim 14, wherein
the content distribution unit selects the content on a basis of the travel destination information or the information of the current location and distributes the content to the moving body in response to a request from a passenger of the moving body.

16. The content distribution system according to claim 1, wherein
the content includes a video, a game, music, audio, and a still image.

17. The content distribution system according to claim 1, wherein
the moving body includes a vehicle, a ship, and an aircraft.

18. An operation method of a content distribution system including: a moving body; and a server that distributes content to the moving body,
the moving body including:
a travel destination information processing unit that executes processing according to travel destination information that is information of a travel destination; and
a content reproduction unit that acquires and reproduces the content distributed by the server,
the server including
a content distribution unit that selects the content on a basis of the travel destination information and distributes the content to the moving body,
the operation method comprising the steps of:
executing, by the travel destination information processing unit, processing according to the travel destination information;
acquiring and reproducing, by the content reproduction unit, the content distributed from the server; and
selecting, by the content distribution unit, the content on a basis of the travel destination information and distributing the content to the moving body.

19. A program causing,
among computers that control a content distribution system including: a moving body; and a server that distributes content to the moving body,
a computer that controls the moving body to function as:
a travel destination information processing unit that executes processing according to travel destination information that is information of a travel destination; and
a content reproduction unit that acquires and reproduces the content distributed by the server, and
a computer that controls the server to function as
a content distribution unit that selects the content on a basis of the travel destination information and distributes the content to the moving body.
